(19) United States
(12) Patent Application Publication
(10) Pub. No.: US 2007/0276901 A1
(43) Pub. Date: Nov. 29, 2007

(54) Method and system for providing a graphical workbench environment with intelligent plug-ins

(75) Inventors: Michael Glinsky, Houston, TX (US); Gilbert Hansen, Plano, TX (US)

Correspondence Address: ANDREWS KURTH LLP, 1350 I STREET, N.W., SUITE 1100, WASHINGTON, DC, 20005, US

(73) Assignee: BHP Billiton Innovation Pty Ltd.

(21) Appl. No.: 11/439,111

(22) Filed: May 23, 2006

(51) Int. Cl. G06F 15/16

(52) U.S. Cl. 709/203; 709/201

(57) ABSTRACT

An apparatus and a method for analysis of point-gathered data. The apparatus and method provide a platform that includes a workbench providing a graphical working environment for a user to view and perform operations on point-gathered data and to interact with the platform, one or more plug-ins that operate on the point-gathered data, including plug-ins that receive inputs from a user through workbench and issue commands as messages and that actively save their state by passing the state as a message, and a message framework that receives all messages from producer plug-ins and passes the messages to an intended consumer. The platform actively saves the workbench state and plug-in states as messages passed to the message framework.

### BACKGROUND

Numerous computer applications exist for providing users with a desktop environment for remotely connecting to and working in a networked computing system. Such networked computing systems may be a workplace, school, business, etc., networked computing system that a user may want to remotely connect to in order to, for example, tele-commute. One known example of such a computer application is Citrix™. However, such computer applications, including Citrix, may be generally characterized as “lite-client.” Lite-client computer applications keep as much functionality and processing on the server-side rather than the client-side (i.e., the user machine). These computer applications do not centralize operations on the client-side and do not have their “brain” on the client-side. Furthermore, such computer applications tend to provide only basic client-side graphic rendering.

Additionally, computer applications and networked computing systems exist that automatically connect to servers and download applications on a client. For example, U.S. Pat. No. 6,854,009 (“the '009 patent”) describes a system for providing voice-over-internet-protocol (VoIP) systems. The '009 patent describes a networked computing system that has a plurality of servers and a plurality of distributed clients. Each client has a boot operating system (OS) that automatically initiates a connection to one of the servers upon startup. The server automatically downloads a base OS and configures a suite of applications on the client.

However, like the Citrix application and other applications and systems, the system described by the '009 patent does not provide or include intelligent components that save their state as part of an active state-saving mechanism. These systems do not support intelligent, user-built and third-party-built, custom components. These systems do not provide a graphical environment with intelligent and inter-communicating components that may actively drive services and other components. These systems do not provide an extensible environment or workbench that supports multiple active virtual desktops. Further, these systems tend to be event-driven rather than utilizing a message-based architecture. Moreover, as above, these systems may be generally characterized as “light-client,” maintaining a greater degree of functionality and processing remotely on a server rather than locally on a client.

### SUMMARY

An advantage of the embodiments described herein is that they overcome the disadvantages of the prior art. Another advantage of embodiments described herein is they provide a user-friendly, graphical web-based workbench environment with intelligent components that are activated on a client when a user connects to a remote server. The components in such embodiments are intelligent in that they include state-saving, state-restoring and message passing capabilities. Another advantage of embodiments described herein is that they support multiple active virtual desktops in a message-driven, extensible environment or workbench. Another advantage of embodiments described herein is that they enable user-built, third-party-built custom components. Yet another advantage of embodiments described herein is that they are heavy-client, centralizing their functionality and processing on a client rather than a server.

These advantages and others may be achieved by a platform for analysis of data. The platform includes a workbench providing a graphical working environment for a user to view and perform operations on point-gathered data and to interact with the platform, one or more plug-ins that operate on the point-gathered data, including plug-ins that receive inputs from a user through workbench and issue commands as messages and that actively save their state by passing the state as a message, and a message framework that receives all messages from producer plug-ins and passes the messages to an intended consumer. The platform actively saves the workbench state and plug-in states as messages passed to the message framework.

These advantages and others may be achieved by a system for providing a graphical web-based environment for performing operations on data. The system includes a client operating on a user machine and a server. The client includes a workbench that provides a graphical working environment for a user to interact with and operate a plurality of components operating in the workbench, and message framework. The components include one or more commanders that analyze and perform operations on data, one or more self-commanders and one or more client-side services (and/or server-side services) that perform services per commander or self-commander issued commands and issues responses to the commands. Each commander includes state-saving, state-restoring and message passing capabilities, receives inputs from the user through the workbench, issues commands and receives responses. Self-commanders receive inputs from the user through the workbench, issue and receive commands, and issue and receive responses. The components communicate with each other using messages passed through the message framework. Each message is passed through the message framework and includes data or data and a command. The server stores information regarding the components, including the state and identity of available components.

These and other advantages are also achieved by a method for providing a graphical web-based environment for performing operations on data. The method includes connecting to a server from a client computer, opening a workbench on the client computer, starting up a message framework, launching one or more commander components on the client computer, launching one or more self-commanders on the client computer and saving the state of at least one of the commander components on the server. These advantages and others are also achieved by a computer readable medium that includes instructions for executing this method.

### DESCRIPTION OF THE DRAWINGS

The detailed description will refer to the following drawings, wherein like numerals refer to like elements, and wherein:

FIG. 1 is a block diagram illustrating an exemplary architecture of system for providing a graphical web-based environment with intelligent plug-ins according to an embodiment;

FIG. 2 is a more detailed block diagram illustrating an exemplary architecture of system for providing a graphical web-based environment with intelligent plug-ins according to an embodiment;

FIG. 3 is a block diagram illustrating an exemplary architecture of exemplary system components;

FIG. 4A is a screen shot of an exemplary virtual desktop according to an embodiment of system for providing a graphical web-based environment with intelligent plug-ins;

FIG. 4B is a screen shot of an exemplary virtual desktop according to an embodiment of system for providing a graphical web-based environment with intelligent plug-ins displayed;

FIG. 5 is a flowchart illustrating an exemplary method for providing a graphical web-based environment with intelligent plug-ins;

FIG. 6 is a flowchart illustrating an exemplary method for providing a graphical web-based environment with intelligent plug-ins;

FIG. 7 is a flowchart illustrating exemplary message passing in a graphical web-based environment with intelligent plug-ins;

FIG. 8 is a block diagram illustrating exemplary hardware components of a system for providing a graphical web-based environment with intelligent plug-ins according to an embodiment.

### DETAILED DESCRIPTION

A method and system for providing a graphical environment with intelligent plug-ins is described herein. Embodiments include a component-based application with an underlying message-driven framework that supports multiple virtual desktops. Each instance of a virtual desktop may be referred to herein as a “workbench” and the component-based application may be referred to herein as “workbench application” or simply the “application.” Each active desktop may have multiple intercommunicating components active at once. The components include two capabilities, namely message passing and saving/restoring of the component's computational state. Embodiments of the workbench include components that send commands to other components and receive responses, components that send and receive commands, process commands, and receive and send responses, and components that receive commands, process the commands and send responses. The components may receive virtually any kind of data as input, run various computational algorithms on the data and produce output that is consumed by other components and also, for example, displayed to a user. In embodiments, the component-based application is a web-based application that is downloaded from a server to a user machine on which it is installed and run/executed. The application may be a “client-heavy” or “thick client” application because the components, particularly the command-issuing components, run predominantly on the client and not on the server.

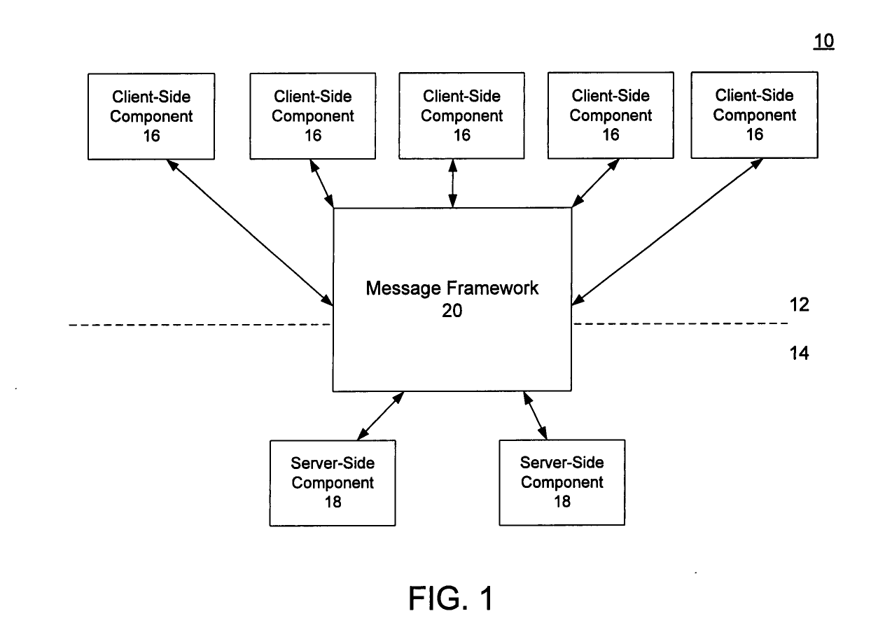

With reference now to FIG. 1, shown is a block diagram providing a general overview or architecture of computer system 10 for providing a graphical web-based environment with intelligent plug-ins according to an embodiment. In an embodiment, system 10 may be accessed and run by a user downloading (or otherwise obtaining), installing and running the component-based application described above on their user-machine (client 12).

Generally speaking, components of system 10 are plug-ins. A plug-in is software (e.g., a module or application) that issues or receives commands to perform certain enumerated operations; new plug-ins may be added to or “plugged-into” system 10 by integrating the plug-in into an exposed application program interface (API) (e.g., message framework) of system 10. New plug-ins extend capabilities of system 10 (“extend the system”). As is discussed herein, the component-based application running on user machine may detect and instantiate the plug-ins as requested by user. The graphical web-based environment is referred to as a workbench. In embodiments described herein, the workbench is a virtual desktop that appears as a window on the user-machine (client); system 10 is a virtual operating system (OS) for the workbench. The architecture of system 10 defines a component-based application with an underlying message-driven framework that supports multiple virtual desktops. Each desktop may have multiple intercommunicating components active simultaneously.

As shown, the system 10 includes client 12 (side) and server 14 (side). The client 12 and server 14 shown are exemplary and are shown for illustrative purposes only. See below for detailed description of exemplary client 12 and server 14. Other configurations of client 12 and server 14 are encompassed. For example, there may be more than one server 14 in an implementation of system 10. A back-up server 14 may be provided.

Client 12 is a local user machine. Client 12 may be any local user machine on which a user installs and runs the application. System 10 is preferably implemented using Java, such as Java 5.0, although other programming languages may be used. Embodiments include a Java Runtime Environment (JRE), such as JRE 1.5, installed on client 12. System 10 may operate in a variety of operating systems installed and running on client 12, such as Microsoft Windows (e.g., WinXP), Linux, Mac OS. Other applications are installed and used as necessary, such as Seismic Unix (SU) if using plug-ins that generate a SU script or Landmark project environment if using Landmark reader and writer services. Seismic Unix may be the format for sub-surface data passed in system 10. Server 14 may be, e.g., a Tomcat server, installed on a remote machine, or even a local user machine. If system 10 is implemented in Java, it may work in Java or a machine dependent language, such as C++, through a Java Native Interface (JNI).

With continued reference to FIG. 1, system 10 includes client-side components 16, server-side components 18 and message framework 20 providing the message-driven, intercommunication between the components. Message framework 20 includes client-side elements and server-side elements and is, therefore, illustrated spanning both client 12 and server 14. System 10 is client-heavy or thick, with a greater proportion of its components, and functionality, on client 12 rather than server 14. Client-side components 16 are stored and executed on client 12. However, state information is saved on and retrieved from server 14. Consequently, a user may restore client-side components 16 to a saved state on any client 12 on which system 10 is installed.

Message framework 20 supports multiple active, intercommunicating components in a workbench. As mentioned above, workbenches are displays generated by system 10 that have a Windows desktop-type appearance and provide a user access to the components and functionality provided by system 10. Each workbench may be displayed as a window or other graphical-user-interface (GUI). Generally, workbenches are generated and displayed on client 12 when user invokes system 10 by connecting to server 14. Further detail on the invocation of workbenches is provided below.

As discussed above, client-side components 16 and server-side components 18 are plug-ins. These plug-ins, however, are intelligent in that they support two specific capabilities—message passing and saving/restoring of their computational state. The former capability enables client-side components 16 and server-side components 18 to intercommunicate through message framework 20. The message passing capability includes the ability to send messages that include commands and/or data, as described below. In an embodiment, to support message passing, a component includes a message handler and message queue. The message queue temporarily stores outgoing and incoming messages and the message handler manages the message queue, adding and removing messages from the message queue. The state saving/restoring capability enables the state of each active workbench, and the components running therein, to be saved and later restarted with the same operational state. In embodiments, each component may pass its state as a message sent through the message framework for storing on server 14. A component state may include the position of a component GUI in workbench window and input parameters entered into said GUI.

In an embodiment, client-side components 16 and server-side components 18 may include “core” components (plug-ins) that are provided with each implementation of system 10. In other words, the application that a user installs and runs on the user machine may include a set of core components. In an embodiment, each instance of the application installed and run on a user machine will include the core components. Additionally, commercial or custom components (plug-ins) may be developed and added to an implementation of system 10 by a user or third-party developer. For example, such commercial components may be developed and provided by an entity other than the entity providing the application and the core components. Commercial components are components that are not provided with the application when installed. Commercial components may be written by any third-party. A user may install and run the application and then download additional commercial components for installation and operation in system 10. Such commercial components may be “plugged-in” system 10. After the commercial components are installed they may be recognized by the application. Commercial components may extend and expand the functionality of system 10. In an embodiment, system 10 is provided with “core” components under an open-source license while commercial components must be separately licensed and purchased. Commercial components may be licensed or not, open-source or not, purchased or free, etc.

With reference again to FIG. 1, in operation, system 10 users interface with workbench, accessing client-side components 16 through GUIs displayed on the workbench, and requesting client-side components 16 perform certain operations and display certain data. In turn, client-side components 16 issue commands and perform the requested operations. Client-side components 16 may issue commands to other client-side components 16 and server-side components 18. Client-side components 16 issuing commands may be referred to as producers. Components processing and responding to commands may be referred to as consumers.

Responses to the commands (output) are generated by consumer components and sent back to the requesting producer client-side component 16 (component issuing command) and/or other components. Responses to commands may also include further commands sent to other client-side components 16 and/or server-side components 18. The commands and responses are sent and received by message framework 20 as messages. Message framework 20 receives messages from a producer component and routes to the appropriate consumer component. If necessary to send to a server-side component 18, message framework 20 may serialize the message before transmitting to server 14. Responses from server-side components 18 may be received and de-serialized by message framework 20 before being passed to the requesting component.

In an embodiment, client-side components 16 are stored on client 12. Client-side components 16 may be, e.g., packaged as a file stored on client 12. For example, client-side components 16 may be packaged as a Java Archive Repository (a .jar or “JAR” file) saved on client 12 (e.g., in a component or plug-in cache). The file includes code that creates an instance of the component when launched and registers the instance with message framework 20. Some client-side components 16 include a graphical-user interface (GUI) for interaction with the user. Such components would also include code to instantiate the GUI and to receive and process user inputs from the GUI. In an embodiment, every component instance runs as a separate thread in system 10.

As mentioned above, system 10 may be used with virtually any type of data. One embodiment described herein manipulates and operates on sub-surface data, including seismic and well log data, gathered from numerous sources. Seismic data includes sub-surface data normally generated or obtained from sound wave propagation through earth. Such sound waves are typically low frequency (e.g., 1 to 100 Hertz). Seismic data may be generated or obtained by looking at seismic reflections showing contrasts in sub-surface material, e.g., as seen from compression data and acoustic components in the propagating sound waves. Well log data (or simply well data) includes data acquired through a hole (well) drilled in the earth, usually expressed as a function of distance (depth) in the well. Such data may be gathered from devices and instruments in the well, from samples taken from the well, and may include pressure, sound and other data. Such data may also include data gathered during drilling the well or from temporarily or permanently down-hole (in the well) sensors and other measuring devices. Such an embodiment may perform quantitative or qualitative interpretation, other analysis or processing, of seismic and well data. Seismic data and well log data are types of sub-surface data. Indeed, when referred to herein, sub-surface data may refer to seismic data, well log data, other related data, and/or derived data (e.g., data derived from sub-surface data, reservoir models, reservoir simulation models, geologic models, etc.). Other data system 10 may be used with includes, for example, medical imaging data, gaming data (e.g., from on-line or standalone computer game applications), financial data, telecommunications data, military application data, security data, weather data, etc. The data may be produced, generated, retrieved, gathered, etc., by separate applications (e.g., web-based or standalone) or by components of system 10. For example, in a gaming embodiment, clients 12 may be separate gamers' user machines and client-side components 16 may include the gaming application installed on client 12. The state of a gamer's game session may be saved on server 14.

The data may be generated on or gathered by computing devices separate from client 12 and server 14. The data may be point-gathered (e.g., gathered at a particular geographic or virtual point, such as, e.g., a seismic-data gathering device, a well, a meter, a medical imaging device, a telecommunication device (e.g., a switching center, base station, wireless transmitter/receiver (e.g., mobile phone), wired transmitter/receiver, fixer or mobile transmitter/receiver, land-line), a financial device (e.g., an automated-teller machine, a computer performing electronic banking, a financial institution computer, an automated trading network or computer), a gaming machine (e.g., a user machine running an on-line or standalone computer game, a server running an on-line computer game), a sensor (e.g., radar, sonar, imaging system, ladar, phased-array radar, synthetic aperture radar, motion-sensor, infrared, pressure-sensor, etc.), message notification system, military or security information gathering equipment and devices, other data gathering equipment and devices, computers, servers, and networks, etc.). The data may be actively or passively gathered.

The data may be communicated to and stored on client 12 and/or server 14 via, e.g., the Internet or another network. The data may be manually loaded onto client 12 and/or server 14. Alternatively, data may be stored on storage devices remote from client 12 and/or server 14. Data may be stored in large amounts (e.g., terabytes of data) on server 14 (or other storage device) and subsets of the data (e.g., megabytes or gigabytes) temporarily, or otherwise, retrieved from server 14 (or other storage device) and stored on client 12 for processing and operations performed by client-side components 16 (such as, e.g., display and manipulation through workbench). In some instances, it may be necessary for a server-side component 18 to perform an operation because the data for the operation is resident on server 14 or elsewhere. Other instances include situations when a computation is particularly intense and it requires multiple server-side components 18 resident on multiple, or a cluster or gird of, servers 14.

With reference again to FIG. 1, to summarize, some important features of system 10 include:
Components are command driven. A component receives/sends either a command and/or data, and returns data. Commands and data are bundled in a message. In embodiments, all messages go through message framework 20, which handles message passing for all components. Message framework 20 may execute commands contained in a message or direct the message to a client-side component 16 or server-side component 18 for execution. Return messages are directed to the requesting originator component.
Client-side components 16 or server-side components 18 are plug-ins that include two specific capabilities, namely, message passing and saving/restoring of computational state.
   Additionally, commands with defined arguments can be journaled into a script. Replaying this script can be used to test system 10 or to restore system 10 to a past state. It is possible to present a script file to the message framework 20 for execution. Other important features of system 10 are apparent from the description above and as follows.

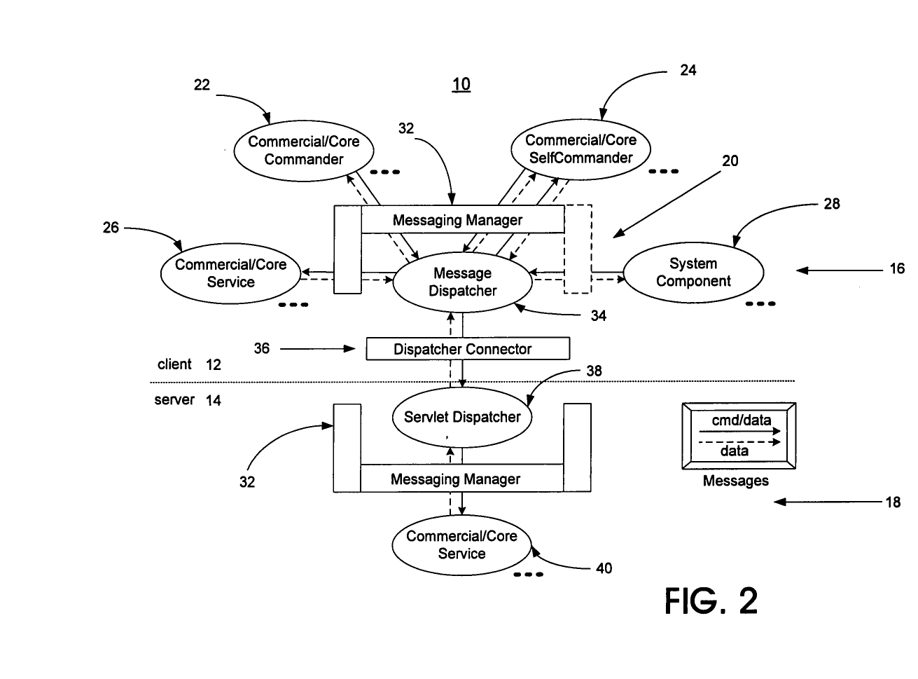

With reference now to FIG. 2, shown is a block diagram illustrating a more detailed, exemplary architecture of an embodiment of system 10. As above, system 10 includes client-side components 16, server-side components 18 and message framework 20. As shown here, client-side components 16 include one or more commanders 22, one or more self-commanders 24, one or more client-side services 26 and one or more system components 28. Message framework 20 includes messaging manager 32, message dispatcher 34, and dispatcher connector 36 on client 12, and servlet dispatcher 38 and messaging manager 32 on server 14. Server-side components 18 include one or more server-side services 40. Commanders 22 and other client-side components 16 are resident and executed on client 12. In alternative embodiments, commanders 22 and other components may be resident and executed on server 14.

Commanders

Commanders 22 are intelligent components. As with other components of system 10, commanders 22 include message passing and computational state saving/restoring capabilities. Commanders 22 generally act as producers, sending commands to other components and message framework. Commanders 22 send requests (commands with or without data) to other components (client-side components 16 and server-side components 18) and receive responses back. Some of the responses may include data generated or retrieved by other components. The data may be retrieved from client 12, server 14 or elsewhere. Commanders 22 may manipulate this data, perform operations, including, e.g., computational algorithms, on the data, and produce output that may be consumed by other components. For example, self-commanders 24 may include viewers which consume output from commanders 22 and display the output on a display in the workbench for the user to view. Commanders 22 include message handlers and message queues as discussed above.

In embodiments, commanders 22 do not receive commands from self-commanders 24 and services (client-side services 26 or server-side services 40). The message paths shown in FIG. 2, by showing outgoing commands/data and incoming data to commanders 22, illustrate this paradigm. An exception to this paradigm is that commanders 22 do receive and respond to commands from message dispatcher 32 and system components 28 (collectively referred to as “system-level components”). All components, including commanders 22, may receive commands from system-level components.

Commanders 22 usually include a GUI through which a user specifies input parameters and selects data for operations performed by commanders 22. Typically, when the user makes selections requesting commander 22 perform some operation, the commander GUI enters into a dialog with a user in order to determine what file or directory to use for obtaining data, to set parameters for commander 22 operations, to determine what file or directory to write results to, etc. Such dialogs may be common to other client-side components 16 and, therefore, may be provided as a separate client-side component 16 for other client-side components 16, such as commanders 22 and self-commanders 24, to use. Some commanders 22, however, do not have a GUI and may, for example, simply monitor and record message traffic and take actions based on received messages and/or drive other components.

With continuing reference to FIG. 2, there are a variety of forms commanders 22 may take. For example, commanders 22 may be: (1) a monitor/report daemon, which commands message framework 20 to feed the monitor daemon the command stream received by message framework 20 and which monitors and reports on the command stream; (2) a monitor/act daemon that monitors commands issued by another commander 22 or self-commander 24 and takes some action when a particular command is issued. For example, as discussed below, self-commanders 24 may include viewers, including three-dimensional (3D) viewers and two-dimensional (2D) viewers. Like commanders 22, self-commanders 24 may include a GUI. A 3D viewer GUI may issue a command to select and highlight a portion of data displayed in the 3D viewer (e.g., in response to a user input, such as clicking-and-dragging over a portion of the display). The monitor/act daemon may be monitoring for such a command, and when seen, the monitor/act daemon may issue a command to the 2D viewer to select and highlight a corresponding portion of data displayed in the 2D viewer. Other commands that may be monitored and acted upon include such commands as “refresh all displays” or “reload a layer”; (3) a recording daemon that records commands to a script file (which may be later executed); (4) a system backup daemon that, periodically or as scheduled, tells messaging framework 20 to save the state of an active virtual desktop; (5) a static command generator, which presents another component (e.g., a self-commander 24 such as a viewer) with a canned script of commands for execution. The static command generator may contain the canned script or ask the user for a script file; (6) a dynamic command generator that issues commands based on actions taken by the user (e.g., actions taken by users in component GUIs or on displays displayed by a self-commander 24). Such a dynamic command generator commander 22 may listen to commands from an active instance of self-commander 24; and, (7) a workflow-wizard or other GUI that receives commands from users in the form of user selections and parameter inputs in the GUI displayed to the user in the virtual desktop, performs operations on selected data (e.g., computational algorithms) and may issue commands to other components in response thereto. The types of commanders 22 include the forms discussed herein, combinations of those forms, and commanders 22 with other functionality limited virtually only by a developer's imagination and compatibility with systems 10 (message passing and computational state saving/restoring).

Workflow wizard commanders 22 may present a workflow through a GUI to users. The workflow may be a flowchart of various actions and operations performed by workflow wizard commander 22 and/or various other components, such as other commanders 22, self-commanders 24, client-side services 26, and server-side services 40. The workflow requests and receives input parameters from the user. The workflow may instantiate components to perform operations displayed in the workflow and selected by the user. The received input parameters may include selections of data for operations and parameters for computational algorithms, for example. The received input parameters may be provided to the instantiated components as input for the operations. For example, a workflow wizard commander 22 may instruct a self-commander 24 (e.g., such as a viewer, client-side service 26 or server-side service 40) to take certain actions in response to a user selection, via commands (sent as messages through message framework 20).

The GUI workflow for a workflow wizard commander 22 may be represented, for example, by a layout of Java Swing™ interaction widgets displayed in the GUI (non-workflow components may use Java Swing interaction widgets). The layout specifies the flow of control—the flowchart. Such widgets may include data widgets and control widgets. Data widgets are for specifying options and entering parameters to computational processes. The computational processes may be performed by the workflow wizard commander 22 or other components. Control widgets are for issuing commands to components, such as self-commanders 24 (e.g., commands to viewers to display computational results).

Commander 22 GUIs displayed in a virtual desktop may have a status area for displaying messages about the progress of computational processes being executed by or for commander 22. Some computational processes executed for commander 22 may be executed by client-side service 26 or a server-side service 40. Exemplary statuses of a commander's 22 computational process include: the process started, the process completed successfully, the process took an exception, or the server the process was running on crashed.

With continuing reference to FIG. 2, commanders 22 monitor and save their current state. As a result, commanders 22 may be suspended, i.e., the state of an instance of a commander 22 saved and the commander 22 deactivated/closed. Later, commander 22 may be reactivated to the last saved state. Furthermore, while commander 22 is deactivated, all responses (data) that commander 22 would have received from server-side services 40 (or elsewhere) may be saved. When commander 22 is reactivated to the last saved state, commander 22 is sent all of the saved responses.

In a sub-surface data embodiment, exemplary commanders 22 include but are not limited to an amplitude extraction component (which provides amplitude extraction from maps, events and seismic data), a delivery lite component (which provides model-based inversion calculations on model-based layers), a spectral decomposition component (which provides spectral decomposition functions), a wavelet extraction component (which extracts wavelets from seismic data and from well logs), an XML editor (which enables a user to edit, e.g., XML data files, structured parameter files, input data files, hierarchical data files, workflow files, etc. Such sub-surface data commanders 22 manipulate sub-surface data, e.g., process and/or analyze seismic or well log data, perform computational algorithms on the sub-surface data, instruct job services to perform computations, produce sub-surface data output, produce processed sub-surface data output, etc. The output produced by sub-surface data commanders 22 may be consumed by other components (e.g., by self-commanders 24, such as viewers).

As discussed above, some commanders 22 may be “core” components shipped with an implementation of system 10 while other commanders 22 are “commercial” components that are separately licensed and/or purchased. In an embodiment, system 10 may be provided with core commanders 22 free-of-charge while commercial commanders 22 are provided by a third-party and may be separately licensed and purchased or otherwise obtained (e.g., free of charge, open-source licensed, etc.). For example, some sub-surface data commanders 22 may be developed and provided by various vendors for installation and use in system 10.

Self-Commanders

With reference again to FIG. 2, self-commanders 24 may send and receive requests (commands). This is represented in the architecture diagram of FIG. 2 by two sets of message arrows—one pair for sending commands, one pair for receiving commands. Examples of self-commanders 24 include viewers that graphically render and display data. Such viewers include, e.g., a 2D viewer and a 3D viewer. In a sub-surface data embodiment, viewer self-commanders 24 display, e.g., graphically rendered seismic, horizon and well data, maps, etc.

Self-commanders 24, such as viewers, may communicate with each other via message framework 20. In other words, self-commanders 24 may send each other messages. Indeed, self-commanders 24 may send commands to other self-commanders 24 and themselves via message framework 20. For example, an active 2D viewer may send an active 3D viewer a command to synchronize the 3D viewer cursor with movement of the 2D viewer cursor. When a user moves the 2D viewer cursor, a synchronized 3D viewer cursor will mimic the 2D viewer cursor movement. Alternatively, a monitoring commander 22 may send a 3D viewer self-commander 24 a command to synchronize upon monitoring 2D viewer self-commander 24 synchronize command. Other viewer actions may also be synchronized. Other commands may be passed between viewers for synchronization and other purposes. Self-commanders 24 also receive and respond to commands from system-level components.

Moreover, viewer self-commanders 24 enable a user to conduct multi-dimensional analysis. For example, a user may view a 3D view of data displayed by a 3D viewer. While viewing, the user may select a portion of the displayed data and request that a 2D viewer display the same portion of data in a 2D view. The 3D viewer self-commander 24 may send a command message launching 2D viewer self-commander 24, if not already active, and instructing it to retrieve and display the selected portion of data in its 2D display. The process may also be reversed, requesting a 3D view of displayed 2D data.

With continuing reference to FIG. 2, as with commanders 22 above, self-commanders 24 may include a GUI through which a user makes selections, enters input and otherwise interfaces with self-commander 24. A viewer self-commander 24 may include code for the GUI as well as code to visualize the viewer display. For example, in an embodiment, viewer self-commanders 24 include viewer GUI agents and viewer visualizer services. Viewers control their display (viewer visualizer service) through their GUIs (viewer GUI agent). Messages may be passed from a self-commander 24 GUI to the self-commander 24 visualizer. These messages may contain commands and data for directing viewer visualizer service to display requested data. For example, a user may select a certain portion of data displayed by a 2D viewer for a zooming. Viewer GUI agent may receive data from other components for display and may then send a message (including the data and commands) to viewer visualizer service. Viewer GUI agent may also receive input from a user requesting certain data be displayed or certain services be performed.

As mentioned above, self-commanders 24 may include a 2D viewer and a 3D viewer. In certain (e.g., sub-surface data) embodiments, self-commanders 24 also includes a well log viewer that displays well log views. Exemplary viewers that may be configured as viewer self-commanders 24, or upon which viewer self-commanders 24 may be based, include, e.g., bhpViewer, Interactive Petrophysics™ viewer, PowerLog viewer, Landmark's SeisCube™ viewer, GeoQuest's viewer. In certain embodiments, when workbench is instantiated on client 12, no particular viewer self-commander 24 is active by default. However, the user can change “Preferences” to indicate a default viewer. Self-commanders 24 may be launched explicitly by the user or programmatically by another component (including, e.g., another instance of self-commander 24 currently running). For example, a 3D viewer self-commander 24 may launch (instantiate) a 2D viewer self-commander 24 if a user requests a 2D view of selected data displayed by 3D viewer. Likewise, commanders 22 may launch self-commanders 24.

As with other components, self-commanders 24 support message passing and computational state saving/restoring. Self-commanders 24 may be producers and consumers. Self-commanders include message handlers and message queues. Self-commanders 24 may be suspended, i.e., the computational state saved and the self-commander 24 deactivated. While self-commander 24 is deactivated, all commands and data self-commander 24 would have received from other components are saved. When self-commander 24 is reactivated to the last saved state, self-commander 24 may be sent all of these commands and data. A user may also specify which change commands it wants an instance of self-commander 24 to broadcast to other instances of self-commander 24 and other self-commanders 24, and which change commands it wants the instance of self-commander 24 to listen for from other instances of self-commander 24 and other self-commanders 24.

Services

With reference again to FIG. 2, client-side services 26 and server-side services 40 receive commands, process the commands and sends back a response (e.g., data). Services may receive commands from commanders 22, self-commanders 24, message dispatcher 32 and system components 28. Examples of client-side services 26 and server-side services 40 are input-output (10) services, such as a reader and writer for files (e.g., ASCII files and seismic files in different formats (e.g., segy, Landmark, Petrel, etc.)), and job services for executing and monitoring jobs generated by commanders 22 or self-commander 24 (e.g., to perform calculations for commanders 22 or self-commanders 24). Client-side services 26 and server-side services 40, generally speaking, are utilities that provide common operations that may be utilized by different commanders 22 and self-commanders 24. Jobs may be a script (e.g., a Seismic UNIX (SU) script) of one or more operations executed by one or more client-side services 26 and/or one or more server-side services 40. Jobs may be run in little time, e.g., micro-seconds or seconds, or may take substantial time, e.g., minutes, hours, days. Some jobs may require one or more server-side services 40 for running jobs on a cluster of servers or computers (which may or may not include server 14). Client-side services 26 and server-side services 40 may assign each job and cluster job a unique job ID.

The following exemplary client-side services 26 may be provided as part of an embodiment of system 10: a reader to read a local file in a given format; a writer to write a local file in a given format; a service to retrieve names of files in a directory (e.g., on client 12); and, a job service to start a local job and monitor the local job progress. Local jobs typically are executed by one or more client-side services 26 running on the user machine (client 12). In an embodiment, an instance of a client-side service 26 can only be started by a command from a commander 22 or self-commander 24.

As with other components, client-side services 26 and server-side services 40 support message passing and computational state saving/restoring. Client-side services 26 and server-side services 40 may be consumers (and, for their responses, are in affect producers). Client-side services 26 and server-side services 40 include message handlers and message queues. Client-side services 26 and server-side services 40 may be suspended, i.e., the computational state saved and client-side service 26 or server-side service 40 deactivated. While client-side service 26 or server-side service 40 is deactivated, all commands and data client-side service 26 or server-side service 40 would have received from other components are saved. When client-side service 26 or server-side service 40 is reactivated to the last saved state, client-side service 26 or server-side service 40 may be sent all of these commands and data.

With continuing reference to FIG. 2, the bulk of commands issued in system 10 (e.g., by commander 22 or self-commander 24) are executed by client-side components 16. However, some commands are executed on server 14. In an embodiment, an instance of server-side service 40 can only be started by a command from commander 22 or self-commander 24. The following exemplary server-side services 40 may be provided as part of an embodiment of system 10: a reader to read a file from server 14 in a given format; a writer to write a file on server 14 in a given format; a service to retrieve names of files in a directory (e.g., on server 14); and a job service to start a server job or a cluster job (e.g., a job executed on multiple servers or computers (a cluster)) and monitor the server job or cluster job progress. The job status may be passed as a message from server-side service 40 and displayed to a user through workbench, such as through commander 22 GUI. If commander 22 or self-commander 24 requesting a job terminates, server-side service 40 may continue the job until completed and then queue the job results for later delivery to commander 22 or self-commander 24 when restored. In the case of a job service requested by commander 22 or self-commander 24, server-side service 40 may contain all of the intelligence for controlling and monitoring the requested job (e.g., computational process). Server-side services 40 that start and monitor a requested computational process (e.g., cluster jobs) are capable of handling requested processes for multiple commanders 22 and self-commanders 24 simultaneously.

In an embodiment, server-side services 40 may be implemented as servlets which can be invoked by servlet chaining using aliases. This servlet chaining may be implemented, for example, using servlet filters and/or RequestDispatchers.

In an alternative embodiment, message passing between services (e.g., between two or more server-side services 40 or between two or more client-side services 26) may be accomplished by having messages go directly from one service to the other and not through message framework 20. Such message passing may avoid message passing overhead.

System Components

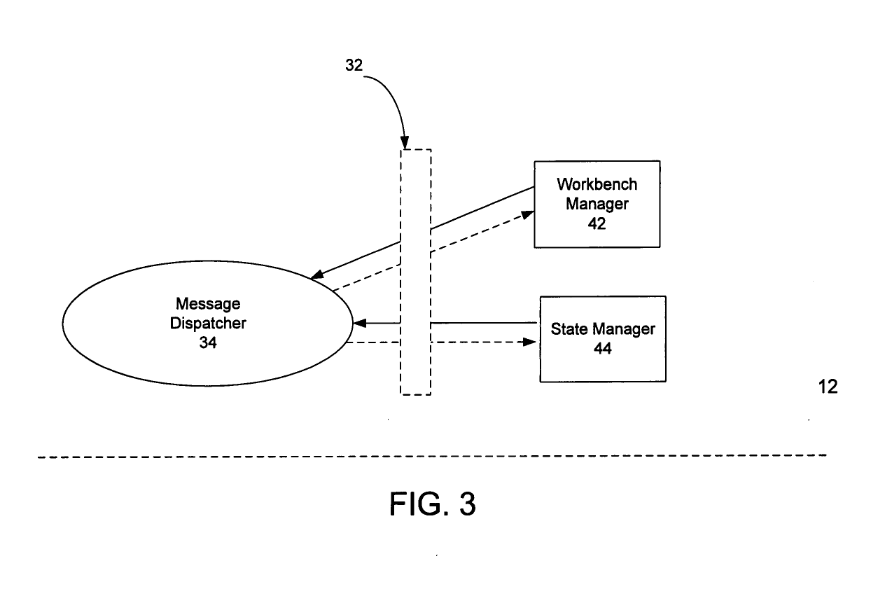

With reference again to FIG. 2, system components 28 are client-side components 16 used to manage system 10 and the workbench (i.e., the virtual desktop). As discussed above, system components 28, along with message dispatcher 32, may issue commands to any other component (including other system components 28). With reference now to FIG. 3, in an embodiment, system components 28 include two components: workbench manager 42 and state manager 44. Workbench manager 42 provides a user all workbench functionality through a GUI. Via workbench manager 42 GUI, a user may invoke client-side components 16, such as commanders 22 and self-commanders 24, save and restore sessions of the workbench (e.g., state of entire active virtual desktop, including each active component and its computational state), determine the version of the workbench being run, determine what components (e.g., commanders 22 and self-commanders 24) are available, etc. See below for further discussion of workbench manager 42.

State manager 44 saves or restores the state of a component and the entire workbench (which includes all active components in the virtual desktop and their state). State manager 44 may maintain each saved state in a session file (e.g., ending in .cfg) which state manager 44 manages. State manager 44 may handle component state information in XML. State manager 44 may save component state information as XML. Component state includes, e.g., component display name, component CID, what was displayed in component GUI, what parameters selected/input in component GUI, what modes selected, if viewer—how data is displayed, what data displayed, and where displayed, what processes being run, where component GUI displayed on workbench (e.g., on workbench canvas—see below), what jobs requested by component (including job IDs—see below), status of requested jobs, etc. Workbench state includes each saved component in workbench session and whether component is active or not (is component GUI open or not). In embodiments, session files are saved on server 14 using a server-side 10 service 40. Since session files are saved on server 14 a saved workbench may be restored from server 14 and on any client 12 (e.g., a user running workbench application on client 12 may select a previously saved session even if that session was started and run on another client 12). Session files may be saved in any file system accessible by server 14. A workbench may be restored from any server 14 with access to the file system on which the state of the workbench is saved.

In an embodiment, a saved session file may be thought of as a state repository for the saved workbench session. When individual component states are saved, the component state is saved in the session file for the workbench. When the state of an entire workbench is saved, the state of each and every component instance active in the workbench is also saved. Also saved when the state of the entire workbench is saved is the “workbench state”, i.e., an indication of whether a component instance that has a saved state in the session file is active or not (e.g., whether component GUI is displayed in workbench). In other words, for each saved component instance in the session file, state manager 44 determines whether that component instance is active. Later when the workbench state is restored, only those saved component instances that were active when the workbench state was saved are restored. Other component instances that were saved, but that were not active when the workbench state was saved, may be restored individually, e.g., by a user selecting the display name of that saved component instance in workbench manager 42 GUI and selecting restore. In an embodiment, whenever a workbench is closed, state manager 44 automatically saves the workbench state (i.e., the indication of which saved component instances were active and which were not active) in the workbench session file. So, for example, if a user starts up a workbench, activates a component instance, saves the component instance state, closes the component instance, and then closes the workbench, the session file will have the saved component instance state and an indication that the component instance was not active when the workbench was closed. If the workbench is restored, the saved component instance will be inactive. The user may then activate the saved component instances by restoring that component instance.

With continuing reference to FIG. 3, through workbench manager GUI, a user may manipulate saved states within a session file. For example, a user may delete a saved state for a component, add a state for a new component, create a state for another instance of a component (a component clone), and restore state for a component. State manager 44 executes these requests.

Message Framework

With reference again to FIG. 2, message framework 20 includes message dispatcher 34, dispatcher connector 36 and servlet dispatcher 38. Message dispatcher 34 receives and processes messages from system 10 components. Message dispatcher 34 routes a command message from the command producer (e.g., commander 22 or self-commander 24) to the consumer (e.g., self-commander 24, client-side service 26, server-side service 40, or message dispatcher 34). The consumer processes the command, which results in a response (e.g., a data message(s)) being returned to message dispatcher 34. If the consumer is a server-side service 40, response message is passed to message dispatcher 34 through servlet dispatcher 38 and dispatcher connector 36. Message dispatcher 34 routes the response message from the consumer to the producer. If there is an exception (error) while processing the request, an abnormal response is sent back to the producer by message dispatcher 34. The producer determines how to handle the exception.

Message dispatcher 34 may be implemented as a separate program thread. Implementing message dispatcher 34 as a separate thread makes message dispatcher 34 highly efficient at processing messages. As with system 10 components, message dispatcher 34 includes a message handler and a message queue. When processing messages, message dispatcher 34 interprets the commands contained in the messages for routing purposes, thereby acting as a command interpreter. Message dispatcher 34 may, e.g., also: execute certain commands sent to it by commanders 22 and self-commanders 24, e.g., send requesting component requested information maintained by message dispatcher 34 (e.g., information about registered components); route received server-side commands to servlet dispatcher 38 for message passing to and execution by server-side service 40; route received commands to intended client-side component 16 consumer; “feed me your command stream”—send all commands to commanders 22 that requested to monitor the message framework 20 command stream (e.g., in order to be able to take certain actions when certain commands appear in the command stream); send change commands to self-commanders, e.g., to synchronize viewer displays (e.g., “synchronize cursor movement” or “synchronize scroll bar movement”). Such change commands may be directly routed to the consumer component identified in a message or may be routed based, e.g., on a routing matrix message dispatcher 34 constructs for broadcasting purposes (see discussion of Intercommunications below).

Message dispatcher 34 may be made aware of all available components during system initialization (i.e., startup of workbench application on client 12). For example, message dispatcher 34 may scan component JAR files for information (e.g., manifest file) about the components. Message dispatcher 34 may scan JAR files for this information so that it may provide the information to workbench manager 42 for populating workbench manager 42 GUI. Component JAR files include, e.g., executable code for the component and a manifest file, which includes the component's main class and component attributes (properties, display name). Workbench manager 42 may send a command to message dispatcher 34 saying “I want to know all available components”. In response, message dispatcher 34 may scan the component JAR files and provide the component descriptor for each available component. Workbench manager 42 may populate menus and one or more trees (see below) with the available component display names. Later, when a component is activated, e.g., through workbench manager 42 GUI (e.g., user selects from menu), the component instance self-registers itself (and its message handlers—see below) by sending a message with its component's component descriptor to message dispatcher 34. As components self-register, message dispatcher 34 forms a list of all components that are active.

With reference again to FIG. 2, dispatcher connector 36 prepares messages for transmission over the Internet, or other network, to servlet dispatcher 38 on server 14. Messages that are to be executed by server-side services 40 are routed to servlet dispatcher 38. Servlet dispatcher 38 is the server-side counterpart of message dispatcher 34. Servlet dispatcher 38 processes and interprets command messages and routes the messages to the appropriate consumer server-side services 40. Server-side service 40 processes the command and returns a response (data) to servlet dispatcher 38, which sends the response to message dispatcher 34, through dispatcher connector 36, for routing back to the producer. Dispatcher connector 36 may prepare a message for transmission over the Internet (to servlet dispatcher 38) by serializing the message. Likewise, when dispatcher connector 36 receives response message from servlet dispatcher 38 over the Internet, dispatcher connector 36 may deserialize the message.

As shown in FIG. 2, in embodiments of system 10, message framework 20 may also include messaging manager 32. Messaging manager 32 provides a messaging interface to message framework 20 for system 10 components. Instead of interacting directly with message dispatcher 34, client-side components 16 and server-side components 18 send and receive messages through messaging manager 32. Messaging manager 32 may include messaging methods used in system 10. In an embodiment, messaging manager 32 and the messaging methods are the API interface for components of system 10. A third-party developing a commercial component (e.g., a commercial commander 22 or self-commander 24) designs their commercial component to interface to system 10 through messaging manager 32 and these message commands. Messaging manager 32 may provide the following services to system 10 components: manage components message queues; send component's request (command) messages to another component via message dispatcher 34; register and unregister component with message dispatcher 34; retrieve information maintained by message dispatcher, e.g., data about a registered component; test for features of a message; route a response to a request to the request sender (producer). Messaging manager 32 may register a component with message dispatcher 34 by sending the component's component descriptor to message dispatcher 34. The component descriptor includes an identification of component's message handler (hosted by messaging manager 32) and a unique, system-wide ID (CID).

In the embodiment shown in FIG. 2, there is logically one messaging manager 32, but programmatically there are two messaging managers 32, one on client 12 and one on server 14. Each messaging manager 32 actually may include different methods that client 12 or server 14 can call. Logically, the messaging managers 32 handle communications between the dispatchers (message dispatcher 34 or servlet dispatcher 38, respectively) and components.

In an embodiment, each system 10 component, when launched/instantiated, has its own instance (copy) of messaging manager 32. Each component's messaging manager 32 includes the component's message handler and message queue. The message handler manages the component' message queue. For example, the message handler contains the queue and methods to operate on the queue, including enqueue (put a message on the queue) and dequeue (take a message off the queue) messages. Messaging manager 32 also has higher level methods to send and receive messages which go through the message handler to perform the operations.

When message dispatcher 34 routes a message to a component, message dispatcher 34 uses that component's message handler to put the message on the component's queue (e.g., hosted by component's copy of messaging manager 32). When a component sends a message, the component forms the message, which contains the target consumer of the message, and calls a send method in the component's messaging manager 32, which in turn calls message dispatcher's 34 message handler to put the message on message dispatcher's 34 queue. Message dispatcher 34 takes the message off the queue (dequeue the message) and routes the message to the consumer component, using consumer component's message handler to put the message on the consumer's queue (which is hosted by consumer's messaging manager 32).

Consequently, in embodiments described herein, all components have a message handler to manage their message queue. Communication is through the message handlers which contain the message queue and are hosted by messaging manager 32. A component's messaging manager 32 include send/receive methods which enqueue/dequeue messages using a message handler. Each component includes its own messaging manager 32 which contains that component's message handler.

One possible exception to this typical arrangement is for system components 28. System components 28 may host their own message handlers and message queues and may interact directly with message dispatcher 34. This is indicated in FIG. 2 with the dashed lines surrounding messaging manager 32 facing system components 28. Consequently, in such an embodiment, each system component 28 interacts with message dispatcher 34 through messaging manager 32, except for system components 28, which may directly interact with message dispatcher 34. Other embodiments include system components 28 interacting through messaging manager 32 some times and directly with message dispatcher 34 other times.

In an embodiment, much of system 10 may be provided to users under an open source license. In such an embodiment, message dispatcher 34, dispatcher connector 36, servlet dispatcher 38, core commanders 22, core self-commanders 24, core client-side services 26, core server-side services 40 and system components 28 may be provided under an open source license. However, such an embodiment may present licensing and ownership issues for commercial components. If a commercial component provided separately were to interact directly with message dispatcher 34, certain open source licenses would require the commercial component to also be open source licensed. However, messaging managers 32 may be provided under a Berkeley BSD license, which circumvents this issue (under some open source licenses, a component interacting through a BSD licensed component to open source licensed components is not required to be open source licensed). Consequently, by interacting through BSD-licensed messaging managers 32, commercial components would not be required to be open source licensed. Likewise, in embodiments that are not provided to users under an open source license, messaging managers 32 may be omitted. In such embodiments, components would host their own message handlers and message queues.

Message Passing

As indicated herein, with continued reference to FIG. 2, normal communication between components follows a request/response paradigm. A command or data is sent in a request message and data is returned in a response message. The requesting component which generated the request message is referred to as a producer. The responding component which receives the request message and generates the response message is referred to as a consumer.

However, exceptions to this paradigm occur. For example, an exception occurs when message dispatcher 34 a synchronously feeds its command stream as data to a monitoring commander 22 or self-commander 24, sends change messages so marked to all viewer self-commanders 24 or asks a component for the component's state. In each case, message dispatcher 34 has a list of intended receivers.

In an embodiment, communication between any two system 10 components is implemented using message handlers and message queues. Each component implements a defined message handler interface. As described above, client-side components 16 and server-side components 18 may implement their defined message handler interface in their messaging manager 32 copy. Components register their message handler instance with message dispatcher 34. As described above, messaging manager 32 may perform this service. In response, message dispatcher 34 returns its component descriptor, which contains message dispatcher's 34 message handler instance to the registering component.

Using the message handler of message dispatcher 34, each component can add to messages to the message dispatcher 34 message queue (e.g., enqueue). Messaging manager 32 (i.e., message handler included in messaging manager 32) passes the message to message dispatcher 34 message handler with appropriate add message. Message dispatcher 34 determines consumer component and passes message to consumer component's message handler, which adds message to consumer component's message queue (hosted with message handler in consumer component's messaging manager 32).

In an embodiment of system 10 implemented using Java 5.0, a Java 5.0 concurrent queue class (e.g., ConcurrentLinkedQueue) is used to implement the message queues. This is a particularly appropriate class given numerous concurrent components will share access to common message queues (numerous components may concurrently access other component's message queues through messaging manager 32 and message dispatcher 34, along with message dispatcher's 34 message queue). In this embodiment, each item in a queue is an instance of the class QiWorkbenchMsg. The following is an exemplary set of methods for enqueuing and dequeuing messages:

```
interface IMsgHandler {
    // allow someone to send me a message
    public void enqueue(QiWorkbenchMsg);
    // get the next message sent to me for processing
    private QiWorkbenchMsg dequeue( );
}
```

An embodiment may have a concrete implementation of this interface, e.g., ConcurrentMsgHandler, that defines the queue and details of the two methods (enqueue and dequeue) that operate on it. It is sufficient that every component have one message handler. As shown above, message dispatcher 34 can send a message by calling the message consumer's enqueue( ) method (through consumer's message handler). Likewise, a component can get messages sent to it from its message queue by calling its dequeue ( ) method.

Upon activation of a component instance, when messaging manager 32 registers a component's message handler with message dispatcher 34, the registration message also includes a component descriptor, as stated above. The component descriptor may include a unique component ID (CID) and component type (e.g., whether a commander 22, self-commander 24, or client-side service 26, and what type of commander 22, self-commander 24 (e.g., 2D viewer) or client-side service 26 (e.g., a IO service)), the component's message handler, and the components display name. The CID is a system-wide identifier for the component. In an embodiment, message dispatcher 34 keeps this information in a hash table keyed on the CID. As noted above, a component's registration causes message dispatcher 34 to return message dispatcher's 34 message handler. After every component is registered, all components can communicate with each other using message dispatcher 34, which accordingly knows all component message handlers.

When enqueue( ) or similar method is executed, the method not only adds the message to the specified message queue, but may also invoke a callback method, notify ( ), which wakes up the consumer component thread. The consumer component then processes the message, generating and sending a response, and checks for more messages in the queue. If there are no messages in the message queue, the component puts itself to sleep until the next message arrives. Other embodiments may have other mechanisms for informing a consumer that a message has been added to its queue. For example, a consumer component may monitor its queue.

Component Intercommunications

With reference again to FIG. 2, as noted above, system 10 components interact via messages. Exemplary interactions are illustrated with the message paths in FIG. 2. Normally, this interaction occurs by one component, a producer component (e.g., commander 22), sending a message to another component, a consumer component (e.g., self-commander 24 or client-side service 26). However, there are times when component (e.g., commander 22 or self-commander 24) listens for certain messages from other components and reacts to these messages. For example, in an embodiment, a viewer self-commander 24 may be instructed by the user to listen for specific data, window and/or layer change messages from an internal window or layer within a window. The user separately instructs the internal window or layer within a window to broadcast the data, window and/or layer change messages. Similarly, a monitor commander 22 may be so instructed.

Each commander 22 and self-commander 24 GUI may provide a menu for each category of messages to be broadcasted. The user can instruct the component to broadcast a class of messages to ALL other components or selected components. Likewise, the user can instruct the component to listen for specific messages in each category. These selections are conveyed in a message to message dispatcher 34, which constructs a routing matrix of the selected components. The user can change the selections at any time, causing the routing matrix to be updated.

Additionally, a component can control routing and listening programmatically. For example, commander 22 or self-commander 24 may tell message dispatcher 34 for what commands commander 22 or self-commander 24 wants to listen; message dispatcher 34 will construct a routing matrix and route the specified commands to the requesting commander 22 or self-commander 24. Commander 22 or self-commander 24 may also programmatically turn on the commander 22 or self-commander 24's own broadcasting. Commander 22 or self-commander 24 may then ask message dispatcher 34 for a list of active components and tell another component, that commander 22 or self-commander 24 wants to interact with, to turn on that component's broadcasting. Commander 22 or self-commander 24 may tell the other component to turn on its broadcasting by sending a command to the other component instructing the other component to listen for certain commands and to broadcast to the producing commander 22 or self-commander 24. Each component generates and marks the commands that component wants message dispatcher 34 to route. Such commands are marked by a ‘route’ flag.

See “Messages” and “Commands” below for further description of messaging and commands.

Virtual Desktops (Workbenches)

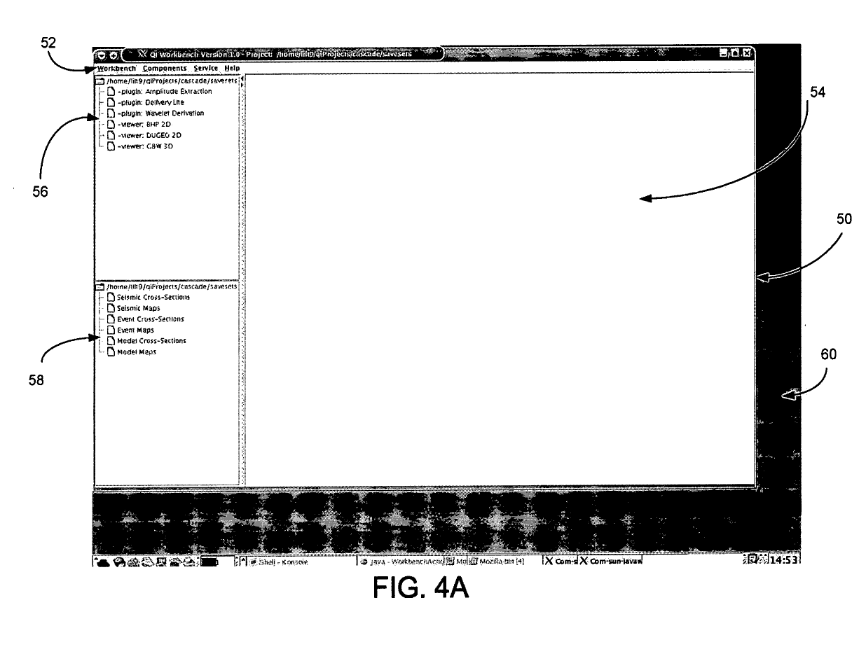

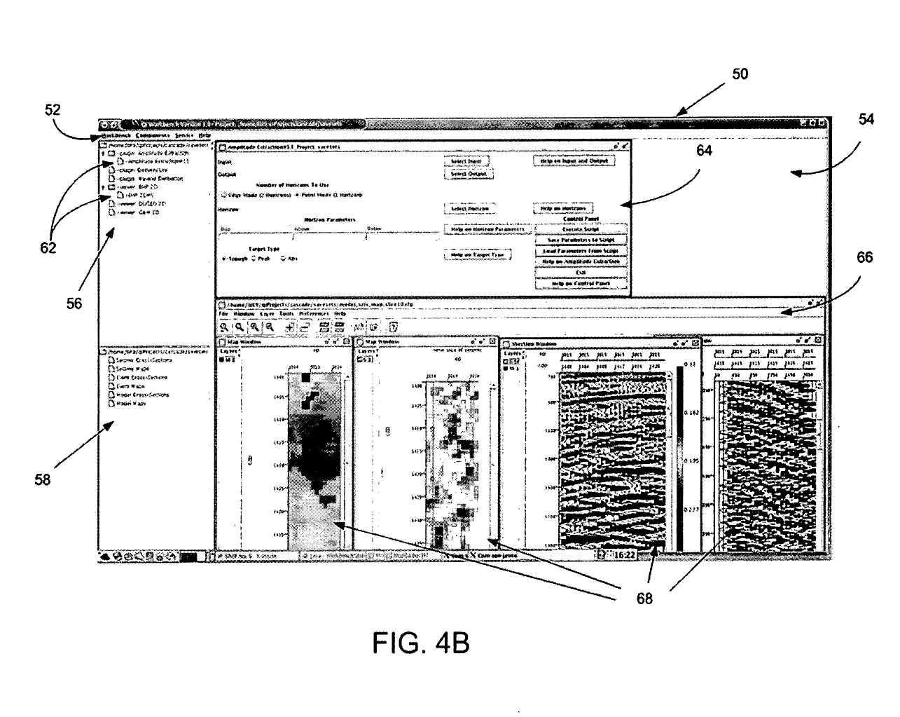

With reference now to FIG. 4A, shown is a screen shot illustrating an embodiment of a virtual desktop, workbench 50. Workbench 50 may appear as a window on client 12 desktop 60. Workbench 50 provides the graphical environment in which system 10 components run and are interacted with by users. Indeed, components, including commanders 22 and self-commanders 24 may generate their own GUIs (e.g., a window) that are displayed within workbench 50, enabling users to interact with and to instruct the component (e.g., input parameters and select options). A user may have multiple workbenches (virtual desktops) 50 open simultaneously on a client 12. In an embodiment, the user may switch between workbenches 50, but only one workbench 50 may be active at a given time. In an embodiment, each workbench 50 represents a separate user session. Accordingly, in such embodiments, communication between workbenches 50 is not supported. In an alternative embodiment, communications between workbenches 50, and components in the different workbenches 50 may be supported. Any GUIs within workbench 50 may be resized, minimized/maximized, moved, etc., and workbench 50 itself may be resized, minimized/maximized, moved, etc.

In an embodiment, workbench 50 includes menu bar 52, canvas 54, navigation tree 56 and dataset analysis tree 58. Menu bar 52 and component/navigation tree 56 together form the GUI of workbench manager (workbench manager GUI) that is used for managing the overall workbench 50 and system 10 environment, as discussed in more detail below. Canvas 54 is the “working” window or frame of workbench 50. Canvas 54 is where component GUIs are displayed. Viewer self-commanders 24 display windows, in which viewers graphically render data that are displayed in canvas 54. Multiple component GUIs and viewer display windows may be displayed simultaneously in canvas 54. Likewise, multiple copies of a component (e.g., commander 22 or self-commander 24) may be launched in a workbench 50 instance and corresponding GUIs and display windows displayed in canvas 54.

Dataset analysis tree 58 is a directory tree that includes a listing of previously performed data analyses (e.g., results of computational algorithms and other operations performed on sets of data by commanders 22). Such data analyses listed in dataset analysis tree 58 may be stored in files in a folder on client 12 and/or server 14. Dataset analysis tree 58 may list data analyses under collapsible/expandable folder paths indicating the location of the folder and the files. Dataset analysis tree 58 may include multiple folder paths listing files in multiple folders on client 12 and/or server 14.

As noted above, multiple workbenches 50 may be active on client 12 simultaneously. As with system 10 components, the entire workbench 50 has state saving/restoring capabilities. Each active workbench 50 running on a client 12 may be suspended and restored, as discussed below in detail. In embodiments, when system 10 is launched, the last suspended workbench 50 may be restored to its previous saved state and re-opened as a default setting. A user may also choose at any time to restore and open any previously suspended workbench 50 to its previously saved state. The user may also choose to restore a currently active workbench 50 to its previously saved state. This, in affect, resets active workbench 50 to its previously saved state.

System 10 provides a desktop environment, workbench 50, that may be used for a variety of purposes. The uses of a given implementation of system 10 are generally determined by the components, particularly commanders 22 and self-commanders 24, that are included with the implementation. In an embodiment, system 10 provides a desktop environment for performing analysis (e.g., quantitative interpretation) of seismic and other data.

Workbench Manager GUI

With continued reference to FIG. 4A, an embodiment of the workbench manager GUI is menu bar 52 and navigation tree 56 portion of workbench 50. As noted above, a user may access all workbench 50 functionality through workbench manager GUI. Through workbench manager GUI, a user may invoke system 10 components (commanders 22 and self-commanders 24), save and restore sessions (e.g., workbench 50 and components' state), determine what commanders 22 are available, etc.

Navigation or component tree 56 is a window pane in workbench 50 containing a directory tree of available components, including commanders 22 (e.g., listed as “plugins” in FIG. 4A), self-commanders 24 (e.g., listed as viewers) and services (client-side services 26 and server-side services 40—not shown), for workbench 50. Such components (core or commercial) are available if they are installed on client 12. The root of navigation tree 56 may be a display name of the particular workbench 50 (e.g., “desktop1”) or the current project name. Tree 56 may include a root node for each available commander 22 or self-commander 24 (e.g., “plugin: Amplitude Extraction”, “viewer: BHP2D”). Note, in the embodiment illustrated by FIG. 4A, self-commanders 24 are all viewer self-commanders 24.

With reference now to FIG. 4B, active instances of commander 22 or self-commander 24 may be displayed as tree sub-nodes 62 in navigation tree 56, and have an assigned display name, which may be a unique name (e.g., “Amplitude Extraction#3” or “BHP2D#6”). Each component instance will have a unique internal name. In embodiments, each component instance's display name is initially set to the internal name. However, a user may change the display name. When state is restored, the display name is as saved, even if no longer the same as the internal name. The user may rename the subnode. The display name for a component instance (e.g, commander 22 or self-commander 24) that has been suspended (state saved and quit) may be shown highlighted (e.g., shown in purple). Any active service instance (e.g., client-side service 26 or server-side service 40) started by a commander 22 or self-commander 24 instance is displayed as a subnode of the commander 22 or self-commander 24 instance subnode (e.g., “service: writeLocalFile” beneath commander 22 instance “myCommandMonitor#1”). The active service subnode disappears when the service completes (normally or abnormally). Double-clicking on an available component name starts a new instance of that component and an instance subnode appears in the tree beneath the component name. Double clicking on a suspended component instance name restores that component instance.

As shown, GUIs 64 and 66, for the active instances of Amplitude Extraction commander 22 and BHP2D viewer self-commander 24, respectively, corresponding to the displayed subnodes in navigation tree 56 are displayed in canvas 54. Also shown in FIG. 4B are active BHP2D viewer self-commander 24 displays 68. A user may open more than one viewer display 68 for an active viewer self-commander 24. As shown and discussed above with reference to FIG. 2, command messages may be sent by viewer self-commander 24 to itself. These command messages may go from viewer self-commander 24 GUI thread to viewer self-commander 24 display thread (“visualizer”). The command messages may include messages launching the display thread, passing selected data for display, manipulating the display per user selections, and other common display controls.

With continued reference to FIGS. 4A-4B, workbench manager 42 GUI also includes menu bar 52. In an embodiment, menu bar 52 may include the following pull-down menus, which are displayed when selected: workbench, component, service and help. Component pull-down menu includes sub-menus which may be separated into commander 22 and self-commander 24 sections.

The workbench menu may include the following selections: New, for starting a new virtual desktop (workbench 50); Open, a submenu for restoring a saved workbench 50 (by opening saved workbench session file); Save As, for saving current workbench 50 state (by saving a clone/copy of workbench session file)—first time a workbench 50 state is saved, dialog asks for location and name for session file (e.g., .cfg file); Save, Quit, for saving current workbench 50 state and quitting (terminating workbench 50); Quit, for quitting (may display dialog asking if want to save state); Rename, for renaming current workbench 50; and Preferences, for setting workbench preferences. The Restore submenu lists all workbenches 50 the user has previously saved (i.e., saved the state of), which may include current workbench 50. Restoring current workbench 50 refreshes current workbench 50 to a previously saved state (see discussion above under state manager 44). Selecting New may open a dialog window that asks the user if they want to save, close (save+quit) or quit current workbench 50. Selecting Rename opens a dialog window in which the display name of current workbench 50 (root node of the component tree) can be changed. Workbench menu may also include a Delete selection to delete a saved workbench session file.

Preferences are configuration settings for workbench 50 set be a user for the user's workbench sessions. For example, the user may specify a default server 14, default project and/or default workbench 50. While defaults are set, each new workbench application session will automatically launch with those settings. A default workbench 50 may be any workbench 50 previously saved by user. A default project is a previously saved project. A project is folder that may include one or more saved workbenches 50. It is generally up to the user what is saved in the project folder. For example, a project may correspond to a real-world project (e.g., a drilling project, a well site, etc.). Workbenches, saved state (session) files (save sets), saved data files (data sets), etc., related to the project may be organized and saved in a project folder. A default server 14 is simply server 14 on which system 10 operates (i.e., which hosts server-side components 18 and from which workbench 50 may be launched). System 10 may operate from a plurality of servers 14. Projects and workbenches 50 are saved on servers 14.

In embodiments, component menu provides selections for managing commanders 22 and self-commanders 24. In embodiments, Component menu includes a Register selection, for registering a commander 22, an Update submenu, a New submenu, a Open submenu, a Save submenu, a Save As submenu, a Save+Quit submenu, a Quit submenu, a Rename submenu, and a Delete submenu. Selecting Register causes a component registration dialog window to pop-up. This registration refers to the registration of a component with system 10, not registration of a component instance with message handler 32 upon launching of the component instance. Only components officially registered (authenticated) with system 10 are available to the user. Generally, core components that are provided with workbench application are automatically registered with system 10 and do not need to be registered by a user. Consequently, in embodiments, only commercial components are available for registering with system 10. The Update submenu displays a list of all available components (e.g., commander 22 or self-commander 24). In an embodiment, core components are automatically updated upon system 10 startup and are not available for updating by user (i.e., not displayed in Update submenu). Selecting an available component in the list causes an update dialog window to pop-up. The update dialog window enables the user to update the selected component, replacing an existing available component with a newer version of component.

The New submenu also displays a list of all available components; selecting an available component starts a new instance of the selected component. The Open submenu is a list of all component instances the user has previously saved (i.e., saved the state of) that are inactive; selecting a saved, inactive component instance causes that component instance to be restored (i.e., opened to component's saved state (e.g., from saved session file)). In an alternative embodiment, the list of saved components instances may include active components; opening an active component refreshes it to a previously saved state. The Save submenu, the Save+Quit submenu, the Quit submenu and the Rename submenu each provide a list of all active components, selectable for saving the selected active component state in workbench session file, saving the selected component state and closing the selected component, closing the selected component and renaming the selected component, respectively. The Save As submenu allows the state of an active component instance to be saved as a clone (new instance), given a unique name, and a new clone instance of component opened in canvas 54. Display name of an active component in tree 56 may be changed via rename. The Delete submenu provides a list of all saved component instances and allows a user to select and delete a saved component instance from a session file. Component menu may also include menu selections for uninstalling available components, checking for updates, downloading new components, etc. In embodiments, such selections are usually limited to commercial components.

With continued reference to FIGS. 4A-4B, service menu includes selections for Status and Quit submenus. Each of these submenus includes a list of all active client-side services 26 and server-side services 40. Selection of a service in the status submenu displays the status of the service in a dialog window. Selection of a service in the quit submenu terminates the service.

With reference again to FIGS. 4A-4B, clicking on the workbench name or a component name in navigation tree 56 displays a context menu pop-up for the selected item. The content of the context pop-up may depend on the state of the selected workbench 50 or component. Selecting the workbench name displays a workbench context menu, which includes selections for opening, saving as, saving+quitting, quitting and renaming current workbench 50. The name of current workbench 50 may denote project or subproject. The restore selection only appears if workbench's 50 state has been saved. Restoring workbench 50 refreshes it to its previously saved state.

Component context pop-up menus include selections for opening a new instance of, opening, saving, saving as, saving+quitting, deleting, quitting and renaming the selected component. If the selected component is a suspended instance, the context pop-up menu includes selections for activating a new instance of, opening (restoring) or renaming the selected component. The opening selection only appears for a selected component if its state has been saved. In an alternative embodiment, the opening selection may also appear for active components may also; opening an active component refreshes the component to its previously saved state.

The service context menu includes selections for status and quitting. If the selected service is active, its status may be queried. An active service may be quit (terminated). Quitting a service removes it from component navigation tree 56.

Workbench Manager

With reference again to FIG. 3, workbench manager 42 may communicate with servlet dispatcher 38 to determine what components (e.g., commanders 22 and self-commanders 24) are available. For example, when workbench manager 42 is launched (i.e., on start up of system 10 on client 12), workbench manager 42 sends a message to servlet dispatcher 38 requesting a list of the available commanders 22. This list is used to populate workbench manager GUI (see FIGS. 4A-4B above). List items may be component descriptors. The list of available commanders 22, and the associated information, may be stored on server 14 in a file or files. For example, the information for the list may be stored in JAR files. The list may be generated by servlet dispatcher 38 scanning the manifest of commander JAR files. The manifest includes various commander 22 attributes, may include the display name, main method name (for launching instance of component), and type of component. The generated list is provided to workbench manager 42, upon request, for populating workbench manager's menus and component tree. The same procedure may be followed by workbench manager 42 to get a list of available self-commanders 24, and similar information may be provided.

As discussed above with reference to FIGS. 4A-4B, the workbench manager GUI may display selections to register and update a component. If register is selected, a dialog window pops up in which the user specifies the (display) name of component and where component is located, e.g., website from which component may be downloaded (as mentioned above, in embodiments, core components are generally automatically registered and generally do not need to be registered with system or updated by user—launching workbench will update core components). This information is sent to message dispatcher 34 which fetches (downloads) the commander attributes (e.g., the JAR file), saves component in a directory and adds the component profile information to a persisted list of components. The persisted profile information about component may include commander's display name, a URL of the component's attribute file (e.g., component JAR file), etc. The component attribute file (e.g., the JAR file) may then be dynamically loaded on client 12. Once dynamically loaded, an instance of new component may be launched in workbench. Updating component works the same way except a new component installation file (e.g., a new JAR file) is fetched which replaces the old one. Persistent storage of component profile information may be a component database, such as, e.g., Hibernate or HSQLDB on client 12. The above describes one exemplary mechanism for obtaining new commercial components. Other mechanisms may be used. For example, a user may manually obtain and install a new component, with registration being completed next time workbench is launched.

If the registration/updating of commander 22 (or self-commander 24) is successful, the display name of commander 22 (or self-commander 24) is added to or update in the commander (or self-commander) menu.

Messages

With reference again to FIG. 2, as mentioned above, each active component of the system has a unique, system wide identifier called the component ID (CID). In an embodiment, CIDs are carried in each message so the producer of a message and the target consumer of a message are uniquely identified. In an embodiment, a CID may be a component's fully qualified Java name (the method which will instantiate an instance of the component), which is unique across the application, e.g., package.class followed by a unique number for different multiple instances.

Each message also has a unique system wide identifier called the message ID (MSGID). The MSGID is set by the producer of a request message and is carried in each response message so the producer can distinguish responses from multiple requests, especially requests to the same consumer such as a client-side service 26. One possible MSGID is a timestamp of when the request message was generated.

In an embodiment, a message is an instance of Java QiWorkbenchMsg class, a serializable object, with the following attributes:
Producer ID—the CID for the producer of a message. Used by message dispatcher 34 to know where to direct a response message.
Consumer ID—the CID for the consumer of a message. Used by message dispatcher 34 to know where to direct a request message.
Message kind. May include:
   CMD, message is a command to be sent to its designated consumer.
   CMD_ROUTE, message is a command to be routed to other agents as determined by message dispatcher 34 routing matrix.
   DATA, message is information to be returned to its designated producer.
   DATA-CMD, message is a command to be treated as data, not to be executed.
Command—a command to be executed by the recipient of the message; usually, a string.
Message ID—the MSGID.
Content type—data type of the message content, usually expressed as a string.
Message content—an object. If the message is a command, the object is its argument(s). If the message is data, the object is the data.

If the message is a command, the Command attribute is not the full command. The command argument(s) are contained in the Content attribute. The reason for this is that it would not be efficient to completely represent a command as a string, as when, for example, an argument is an instance of a class, i.e., an Object. The bulk of message passing is on client 12, so the message object can be passed as a parameter in a Java method. When the message object is sent to servlet dispatcher 38 running on a remote machine, the message object may be serialized into XML, e.g., using XStream (see http://xstream.codehaus.org), by dispatcher connector 36. The XML is received and deserialized into an object by servlet dispatcher 38. Alternatively, system 10 could use a Java Serialization API to flatten an object to a byte file and restore it to an object from the byte file. In this case, both the message and the message content must be serializable objects. To use the objects, they must be cast to their correct type.

Journaled commands may be serialized into XML, e.g., using XStream. A serialized command script file therefore consists of a sequence of commands in their XML representation.

Consumers of a command message may decode a command, e.g., by calling methods in a Java CommandDecoder class. The consumer of the message must know the data type of the message content in order to process it; it is up to the consumer to cast the object to its data type. The content's data type is carried with the message for cases where it necessary to distinguish the type.

In order for a producer of a command to be able to identify returned responses (the producer may have sent out multiple commands), the producer must set the MSGID of a command and maintain a list of commands by MSGID for which the producer is waiting for a response. A response will carry the request's MSGID. The MSGID also serves to distinguish responses from different consumer instances such as a service. For example, a commander 22 or self-commander 24 may request three (3) different files be read by a reader server-side service 40. The returned messages containing the files would have a different MSGID the producer can use to determine which read request the response matches.

Commands

With reference again to FIG. 2, commands are produced by commanders 22, self-commanders 24, message dispatcher 34, and workbench manager 42. The following is a summary of different exemplary commands that may be generated by an embodiment of system 10:

Commander 22 Commands:
Ask message dispatcher 34 for list of available services. For commander 22 (or self-commander 24) to know the CID of a target client-side service 26 or server-side service 40, commander 22 may ask message dispatcher 34 for a list of available services. Each list item contains the CID of a service and a description of the service so commander 22 can distinguish between services.
Instruct service to perform specified service—instructs client-side service 26 or server-side service 40 to perform service.
Monitor message dispatcher 34 command stream (instructs message dispatcher 34 to send commands received by message dispatcher 34).
Refresh viewer self-commander 24 displays—instructs viewer self-commanders 24 to refresh displays.
Tell me the state of a service—instructs client-side service 26 or server-side service 40 to provide state of service (e.g., in-progress, complete, stalled, etc.).

Self-Commander 24 Commands:
Synchronize cursor on viewer self-commander 24 display; target consumer is corresponding viewer self-commander 24.
Synchronize scroll bar on viewer self-commander 24 display; target consumer is corresponding viewer self-commander 24.
Read a file—instructs reader client-side service 26 or server-side service 40 to read a file, provide data from file to self-commander 24.
Write a file—instructs writer client-side service 26 or server-side service 40 to write a file.
Get list of other self-commanders 24 (e.g., other viewers) (from message dispatcher 34).
Get the CID of my display visualizer (if display visualizer of viewer self-commander 24 has separate CID, gets CID of corresponding display visualizer from message dispatcher 34).

Common Component Commands:
Register/Unregister me (sent to message dispatcher 34 to register or unregister producer component (e.g., commander 22, self-commander 24 or client-side service 26)). Includes, e.g., CID, type of component, description, display name.
Send me component descriptor of a component which contains component message handler (sent to message dispatcher 34).
Save my state (sent to state manager 44 to save state of component).
Restore my state (sent to state manager 44 to restore state of component).
Get me a list of files in a directory
Report an error in processing of request

Message Dispatcher 34 Commands:
Give me the list of server-side services 40 (sent to servlet dispatcher 38).
Give me the list of available components (e.g., commander 22, self-commander 24, client-side service 26 or server-side service 40) (sent to servlet dispatcher 38).
Give me a list of jobs and cluster jobs and their status (sent to servlet dispatcher 38 to request list of jobs being performed by server-side services 40 and status of jobs).
Give me job/cluster job status (sent to servlet dispatcher 38).
Give me a list of saved virtual desktops (workbenches 50) (sent to servlet dispatcher 38).

Workbench Manager 42 Commands:
Save desktop state (saves selected workbench 50 state)—sent to state manager 44.
Save desktop state and quit application (saves selected workbench 50 state and closes application (i.e., all active workbenches 50, components, message framework 20, etc.))—save command sent to state manager 44, quit command sent to message dispatcher 34.
Start a saved desktop (restores a saved workbench 50)—sent to state manager 44.
Quit application.
Register new commander 22 or self-commander 24 (e.g., register new commercial component with system 10).
Update commander 22 or self-commander 24 (e.g., update commercial component).
Launch commander 22 (starts commander 22 instance thread)—sent to message dispatcher 32.
Launch self-commander 24 (e.g., a viewer) (starts self-commander 24 instance thread)—sent to message dispatcher 32.
Kill commander's 22 (or self-commander 24) computational process—interrupts and terminates commander's 22 (or self-commander's 24) computational process —sent to message dispatcher 32.
Activate yourself (activates and displays component GUI in workbench 50)—sent to commander 22 or self-commander 24.
Deactivate yourself (deactivates and closes component GUI in workbench 50)—sent to commander 22 or self-commander 24.
Give me a list of active components (sent to message dispatcher 34). Server-side services 40 are always active.
Give me a list of non-active available commanders 22 (or self-commanders 24) (sent to message dispatcher 34).
Give me a list of non-active local services (client-side services 26) (sent to message dispatcher 34).
Give me a list of non-active viewers (i.e., viewer self-commanders 24 (sent to message dispatcher 34).
Give me status of a job or cluster job (sent to message dispatcher 34).

State Manager Commands:
Give me your state (sent to component (e.g., commander 22, self-commander 24 or client-side service 26) to request state of component).
Save component state (sent to servlet dispatcher 38 via message dispatcher 34 to request that state of component instance be saved). Parameters may include, e.g.: CID for component, state of component, user id and desktopName (name of virtual desktop in which component instance is running).
Get saved component state (sent to servlet dispatcher 38 via message dispatcher 34). Parameters may include, e.g.: CID for component, user id and desktopName (name of virtual desktop in which component instance is running).

Launching Workbench System

With reference again to FIG. 2, the workbench application implementation of system 10 is a client-server application. Embodiments of the workbench application run under the Tomcat Web Servlet container. Server 14 (e.g., a Tomcat server) runs either remotely on a separate machine or locally on the user's machine (i.e., on same machine as client 12). In an embodiment, each component comprising the application is a separate thread which performs its own initialization.

In an embodiment, server-side components 18 are server-side services 40 (e.g., servlets) and servlet dispatcher 38, as discussed above. In an embodiment, servlet dispatcher 38 either knows about all server-side services 40 or can learn about them if each is packaged in, e.g., separate JAR files with manifest files itemizing their properties. If the latter, the JAR files may be stored in a library directory (e.g., “lib” directory stored on server 14), from which servlet dispatcher 38 can access and scan the manifest files. The manifest files contain a property that identifies the JAR file as for a server-side service 40. In a similar manner, servlet dispatcher 38 can learn about available core client-side components 16 (commanders 22, self-commanders 24 and client-side services 26). Message dispatcher 34 may learn about commercial components installed on client 12.

In an embodiment, once system 10 is deployed to server 14 (e.g., Tomcat), the user may accesses a main installation web page of system 10 via a browser which contains a Java WebStart™ link. For example, a user may enter a Universal Resource Locator (URL) for the installation web page of system 10 into a web-browser (e.g., Internet Explorer™ (IE), Firefox™, Opera™, Safari™, Netscape Navigator™) and follows specified steps provided by installation web page to install application, including client-side components 16, onto client 12. Client-side components 16 only need be installed once (e.g., using this link)—once installed, for example, a WebStart desktop icon may be created on client's 12 desktop (e.g., client desktop 60—see FIG. 4A). Thereafter, the user can launch/start the workbench application (access system 10) on client 12 using the WebStart desktop icon. Client-side components 16 provided with installation of system 10 are saved and loaded on client 12. Client-side components 16 may also be packaged in, e.g., separate JAR files with manifest files itemizing their properties. JAR files, downloaded and saved on client 12 during installation may be stored in a library directory, from which workbench manager 42 can access and scan the manifest files. In embodiments, primary copies of core client-side components 16 are maintained on server 14. When application is installed on client 12, executable copies of client-side components 16 are downloaded and saved on client 12. Instances of client-side components 16 are launched from these copies. However, in embodiments, servlet dispatcher 38 may more readily locate and obtain information from the primary copies on server 14.

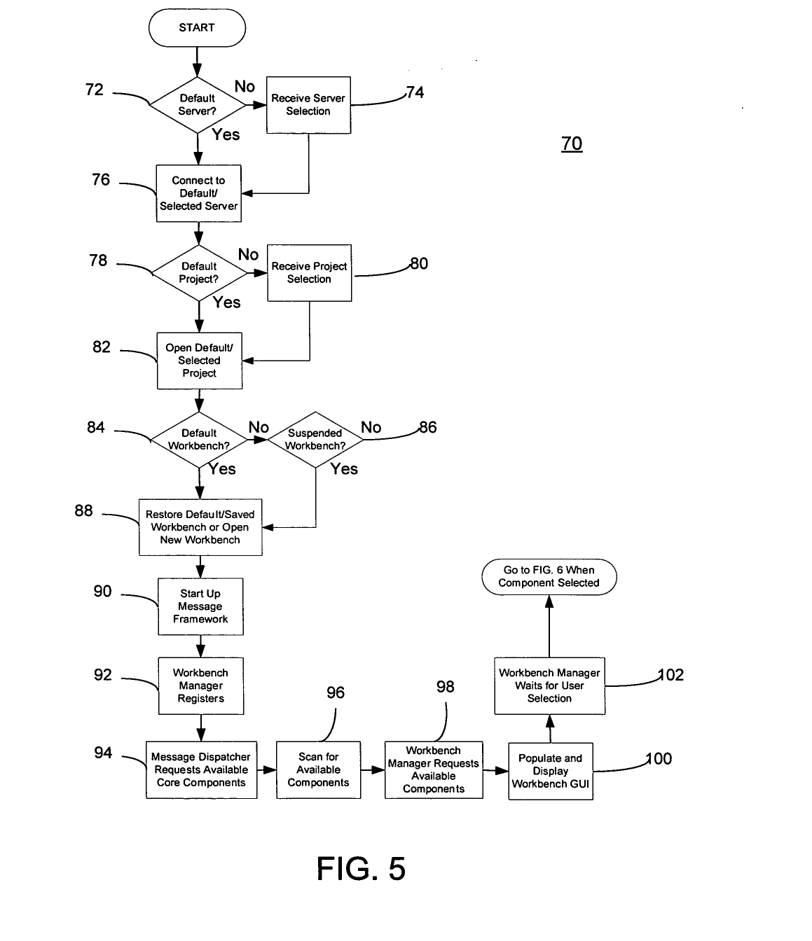

Launching the workbench application (e.g., directly from a system 10 website or by clicking WebStart desktop icon) starts execution of the workbench manager's 42 initialization routine. With reference now to FIG. 5, shown is a flowchart illustrating the initialization routine, an embodiment of method 70 for providing a graphical web-based workbench environment with intelligent plug-ins. Workbench manager 42 may determine if user has set a default server (see preferences above, with reference to FIGS. 4A-4B) (block 72). If not, workbench manager 42 starts dialog with user (e.g., display server dialog GUI requesting user select or enter server 14) and receive user server selection (block 74). Workbench manager 42 connects to default or selected server (block 76). Workbench manager 42 may determine if user has set a default project (see preferences above) (block 78) and, if not, start dialog with user (e.g., display project dialog GUI requesting user select or enter project) and receive user project selection (block 80). Workbench manager 42 opens selected/default project folder on server 14 (block 82). Workbench manager 42 may determine if user has set a default workbench (block 84) and, if not, determine if user has any suspended (saved) workbenches 50 (block 86). If the user does not have a default workbench 50, but, has any suspended workbenches 50, the latest one may be automatically restored; otherwise, a new workbench 50 is created (block 88). In an embodiment, a default or new workbench 50 may be instantiated with a Java webpage invocation using a URL that points to Java code on server 14 that invokes workbench 50 as shown in FIG. 4A. If restoring default or suspended workbench 50, saved states of workbench 50 and active components are obtained from server 14 to further populate workbench 50. If there are any saved data sets in open project folder, they may be displayed in dataset analysis tree 66.

Workbench manager 42 starts up message framework 20, specifically starting message dispatcher 34 thread and calling message dispatcher's 34 initialization method (block 90). The workbench manager 42 receives message dispatcher 34 component descriptor, which includes message dispatcher's 34 message handler, when instantiating message dispatcher 34. Afterwards, workbench manager 42 registers itself and its message handler with message dispatcher 34 (block 92). Message dispatcher 34 asks servlet dispatcher 38 for a list of all server-side services 40 and available components (e.g., commanders 22 and self-commanders 24) (block 94). In response to this request, servlet dispatcher 38 may scan for available core components, e.g., by scanning JAR files looking for available components (e.g., commanders 22 and self-commanders 24) (block 96). In this manner, components that ship with workbench application get recognized as available. Likewise, message dispatcher 34 may scan for available commercial components (e.g., scan commercial component JAR files in component cache).

Workbench manager 42 may ask message dispatcher 34 for all available components in system 10 (block 98). In an embodiment, workbench manager 42 may ask for available components before blocks 94-96. Workbench manager 42 may then display workbench manager GUI in displayed workbench 50, populating the workbench manager GUI with available components determined as set forth above (block 100). Workbench manager 42 waits for user to take action in workbench manager GUI (e.g., make selection to launch a component), and issues messages in response to user actions (block 102).

System 10 may optionally display a login dialog window before the beginning of the process described above. For example, the login dialog window may be displayed as soon as user accesses system 10 website or selects WebStart desktop icon to launch application. User logins through login dialog window. After the user is authenticated, system 10 proceeds to launch workbench 50 and proceed to execute method 70.

Note that system 10 initialization process described does not mention automatically launching any components on startup of workbench 50 (e.g., viewer self-commander 24). In an embodiment, components are not automatically launched, but must be explicitly activated by the user. However, the user may set an option/preference to start up workbench 50 with a component or components active.

Suspending and Restoring Workbench

When using system 10, a user may wish to quit for the day, but want to pick up later from where they left off on the same user machine (client 12) or a different user machine (client 12). System 10 provides this ability, by having the ability to save the state of an active workbench 50 and restoring workbench's 50 saved state later. The state of workbench 50 includes the state of all components active in workbench 50. Saving the state of a workbench 50 thus comprises collecting the state of each active component in workbench 50 and the workbench state itself (e.g., which component GUIs active and displayed in canvas 54), and saving the state on server 14. Restoring workbench 50 includes reinstating the saved state of each component and the workbench state at the time the state of workbench 50 was saved. If re-instating the saved state of an active workbench 50, system 10 reinstates the state of all previously saved components. Only components that were active when workbench 50 was saved are active when it is re-instated.

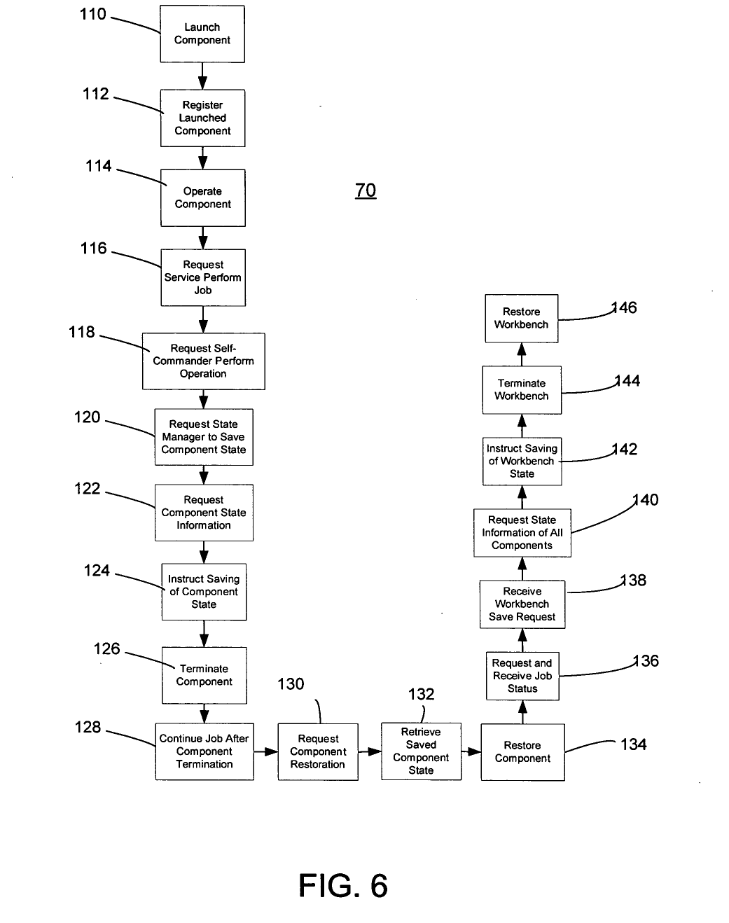

With reference now to FIG. 6, shown is a flowchart illustrating further steps of method 70 for providing a graphical web-based workbench environment with intelligent plug-in, including exemplary launching, saving and restoring of components and workbench. The example shown here is for commander 22, but the same may apply for other components, such as self-commanders 24. Workbench manager receives user selection of available commander 22 (e.g., from pull-down menu on workbench manager GUI or component context pop-up menu (see FIG. 4A-4B description above)) and launches commander 22 (block 110). If commander 22 has a GUI, commander 22 GUI is displayed on workbench 50 (e.g., in canvas 54). Messaging manager 32 instance for commander 22 is created and commander 22 instance and its message handler are registered with message dispatcher 34 (block 112). User uses or operates commander 22, for example, entering input parameters and selecting specific operations to be performed through commander 22 GUI (block 114). Certain operations may cause commander 22 to request a service (e.g., command client-side service 26 or server-side service 40 to read data from client 12 or server 14 or perform a job) (block 116). Likewise, commander 22 may command self-commander 24 to perform some operation (e.g., request viewer to graphically render results of a computational operation or synchronize cursor movement) (block 118).

User may request saving of commander 22 state, which causes workbench manager 42 to send command to state manager 44 to save commander 22 state (block 120). Message with state save request includes CID of commander 22. State manager 44 may send message to commander 22 requesting commander's 22 state information (block 122). When the state information is retrieved, state manager 44 in turn instructs servlet dispatcher 38 to save commander's 22 state on server 14 (block 124). Embodiments of system 10 include a server-side service 18 (e.g., servlet) that performs the state-saving operations on server 14.

Alternatively, components may send messages to state manager 44 with the component's state for automatic saving of component state. Such messages may be sent on a periodic basis, similar to a timed-backup. As mentioned above, system 10 may include components that perform this periodic backup of state (e.g., workbench and/or component state). Such automatic state saving may be set up under user workbench or component preferences.

User may terminate commander 22 (block 126). If any requested jobs are still in progress when commander 22 terminates, the requested job may continue after commander 22 termination until complete (e.g., minutes, hours, days, etc.) (block 128). When components' (including commander 22 and job service instances) states are saved, the saved states may include pending requested job information (e.g., job IDs and job status). If commander 22 and job service (client-side service 26 or server-side service 40) state has been saved with job information when commander 22 is terminated, the job result may be retrieved when commander 22 is reinstated for that workbench 50. The job result may have been saved to a user requested file. When commander 22 is reinstated, job service requests job status and job status is returned with job result (block 136). If job completed normally, job result may be standard, expected output of job. If job terminated abnormally or another error was encountered, job result may be error message. This process of continuing jobs after commander 22 termination may apply to other services besides jobs in progress when commander 22 terminates.

With continuing reference to FIG. 6, user may request restoration of commander 22 (block 130) (e.g., select open in component pull-down menu and selected available, saved commander 22—see above). When workbench manager 42 receives restoration request, workbench manager 42 sends a command to state manager 44. State manager 44 in turn instructs servlet dispatcher 38 to retrieve commander's 22 state from server 14 (block 132). Embodiments of system 10 include a server-side service 18 (e.g., servlet) that performs the state-retrieving operations on server 14. The state information is sent in a response message back to state manager 44, which then sends message to commander 22 instructing commander 22 to restore its state (block 134). As noted above, launching, state-saving and restoring of self-commanders 24 may be performed in the same manner as described above and illustrated in FIG. 6 for commanders 22.

To save and restore a virtual desktop (workbench 50), similar actions are performed. User may request saving of workbench 50 state (e.g, through workbench manager GUI), which causes workbench manager 42 to send command to state manager 44 requesting state of workbench 50 (and all open components) be saved (message includes workbench 50 name or other ID) (block 138). State manager 44 requests state information from all active client-side components 16 (including workbench manager 42) (block 140). State manager 44 may also request status and save of all pending services. Once state information is received, state manager 44 instructs servlet dispatcher 38 to save workbench state and client-side components 16 states on server 14 (block 142). The workbench state and components state may be saved as a .cfg file(s). Embodiments of system 10 include server-side service(s) 18 (e.g., servlet) that performs the state-saving operations on server 14. This state information may include status of pending server-side services and jobs. If workbench 50 is terminated (block 144), pending server-side services and jobs may continue as discussed above. Workbench 50 may be restored as described above (block 146). For example, state manager 44 may instruct servlet dispatcher 38 to retrieve workbench 50 state and saved state of all client-side components 16 from server 14. Embodiments of system 10 include a server-side service(s) 18 (e.g., servlet) that performs the state-retrieving operations on server 14. The state information is sent in a message back to client 12 and workbench 50 is restored. Once restored, user may continue use of workbench 50 and system 10.

Login and Security

In some embodiments, users must login before they can use system 10. In an embodiment, login requires a user to enter their user id and password. System 10 may include a database of registered users that contains their profile information. Part of a user's profile may be a role which controls the user's access rights to system 10.

User's may be restricted to accessing certain client-side components 16 (and/or server-side components 18) based on privileges or additional roles. A user only needs to log-in once. Embodiments may includes an option to remember their user id and password on the computer they are logging-in from. This login information may be saved, for example, in a cookie on user's machine. In an embodiment, servlet dispatcher 38 handles security. Accordingly, servlet dispatcher 38 determines what components a user can access, controls user's realm of control, etc.

Exemplary Commanders

As discussed above, system 10 may include a number of core commanders 22 and self-commanders 24 that are provided or packaged with implementations of system 10 and commercial commanders 22 and self-commanders 24 that are developed and provided separately (e.g., by third-parties) for addition to system 10. In a sub-surface data embodiment of system 10, the following commanders 22 may be provided (as core or commercial). The exemplary commanders 22 below perform multi-dimensional analysis of data through their computational analysis and displays on viewer self-commanders 24 (e.g., 2D, 3D and well-log viewers).

Wavelet Extraction Commander

Wavelet extraction or derivation commander 22 is invoked as other commanders 22 discussed above. The wavelet extraction commander 22 may run a well-tie and wavelet extraction tool. Wavelet extraction commander 22 estimates wavelet coefficients, other parameters associated with uncertainty in time-to-depth mapping, positioning errors in the seismic imaging, and useful AVO-related parameters in multistack extractions. Wavelet extraction commander 22 is capable of multistack and multiwell extractions. Wavelet extraction commander 22 performs multi-dimensional analysis of data (e.g., uncertainty and estimation analysis). An exemplary wavelet extraction tool is described in “Wavelet extractor: A Bayesian well-tie and wavelet extraction program,” James Gunning, Michael E. Glinsky (Feb. 21, 2005), Computer & Geosciences 32, p. 681-695 (2006), is hereby incorporated by references (see also http://oplink.net/˜glinsky/tech_papers/WaveletExtraction_cg.pdf). Set-up parameters for a wavelet extraction commander 22 that may appear in wavelet extraction commander 22 GUI displayed to user on workbench 50 may include:
The filepath of an Extensible-Markup Language (XML) file, e.g., ModelDescription.xml, that specifies parameters needed for the wavelet extraction. This file may be stored on server 14.
The filepaths of the near offset seismic data and the far offset seismic data files. This data may be stored on server 14.
The filepath of the well log file. This file may be stored on server 14.
The filepath of the output synthetic seismic traces data file. This file may be stored on server 14.

Wavelet extraction commander 22 GUI may also include an Edit button that is active once the path is entered. Selecting the Edit button invokes an XML Editor (see below) to edit the above-mentioned XML file. After editing the XML file, it can be saved. When all of the input and output parameters have been specified, the user may select an OK button and the wavelet extraction commander 22 performs the wavelet extraction with the specified parameters. When wavelet extraction commander 22 has completed wavelet extraction, the user may add the resulting data file (e.g., displayed in dataset analysis tree 66) as a layer on a compatible view—e.g., on a display of a viewer self-commander 24, such as a well-log or 3D viewer. In other words, user may launch a viewer self-commander 24 and load result data file generated by wavelet extraction commander 22. Alternatively, wavelet extraction commander 22 may automatically launch viewer self-commander 24 and send it result data. Wavelet extraction commander 22 may utilize well-log and 3D viewer to display.

Amplitude Extraction Commander

Amplitude extraction commander 22 is invoked as other commanders 22 discussed above. Amplitude extraction commander 22 may run an amplitude extraction tool, such as the exemplary tool described in the paper “Integration of Uncertain Subsurface Information Into Multiple Reservoir Simulation Models,” Michael E. Glinsky et al., The Leading Edge, pages 990-999 (October 2005), which is hereby incorporated by reference (see also http://oplink.net/˜glinsky/papers_refereed/tle_stybarrow_{—}05.ndf). Amplitude extraction commander 22 extracts amplitudes and analyzes extracted amplitudes to generate volumetric and risk estimates. Bayesian probabilistic techniques may be used extensively in the process.

Parameters such as described in the paper may be entered through amplitude extraction commander 22 GUI. Such parameters may be selected from data displayed by viewer self-commanders 24. For example, seismic data for the amplitude extraction may be selected from data displayed on a 2D or 3D viewer, e.g., as prompted by amplitude extraction commander 22. Furthermore, a user may select a region or area on a map displayed on a 2D viewer on which the amplitude extraction is to be performed, e.g., as prompted by amplitude extraction commander 22. For example, amplitude extraction commander 22 may send a command message launching viewer self-commander 24 and requesting that it obtain and display map or other data. Viewer self-commander 24 may send as response the data (e.g., area on map) selected by user. Amplitude extraction commander 22 may then retrieve necessary additional data (e.g., associated with selected area on map), e.g., by sending command messages to client-side service(s) 26, if data on client 12, or server-side service(s) 40, if data on server 14 or elsewhere. Alternatively, amplitude extraction commander 22 may send command messages to server-side services 40 to perform necessary computational operations on data, if data on server 14 or elsewhere, rather than retrieving the necessary data and performing operation on client 12. Such computational operations may be requested and performed as a cluster job. Only the computational results would then be returned to amplitude extraction commander 22. In this manner, client 12 processing load may be reduced. Other commanders 22 may operate in this manner. Amplitude extraction commander 22 may also request viewer self-commander 24 display the results (resulting data file). Resulting data file may also be displayed as above.

Delivery Lite Commander

Delivery Lite commander 22 is invoked as other commanders 22 discussed above. Delivery Lite commander 22 may run a tool for model-based Bayesian seismic inversion. Such a tool may be the exemplary tool described in the paper “Delivery: an open-source model-based Bayesian seismic inversion program,” James Gunning and Michael E. Glinsky, Computers & Geosciences 30, pp. 619-636 (2004), which is hereby incorporated by reference (see also http://oplink.net/˜glinsky/tech_papers/DeliveryPaper.pdf). Delivery Lite commander 22 may operate in system 10 as described above for wavelet extraction commander 22 and amplitude extraction commander 22.

Spectral Decomposition and Stratigraphic Flattening Commander

Spectral decomposition and stratigraphic flattening commander 22 is invoked as other commanders 22 discussed above. Spectral decomposition and stratigraphic flattening commander 22 may run a tool for estimating lithofacies probabilities given a seismic wavelet response via a Bayesian inversion. Such a tool may be the exemplary tool described in the paper “Geologic Lithofacies Identification Using the Multiscale Character of Seismic Reflections,” Moshe Strauss, et al., Journal of Applied Physics, pp. 5350-5358 (Vol. 94, No. 8, Oct. 15, 2003), which is hereby incorporated by reference (see also http://oplink.net/˜glinsky/papers_refereed/i_appl_phys₁₃ wavelet_id_{—}03.pdf). Spectral decomposition and stratigraphic flattening commander 22 may operate in system 10 as described above for wavelet extraction commander 22 and amplitude extraction commander 22

Massaging and Decorating Commander

Massaging and decorating commander 22 is invoked as other commanders 22 discussed above. Massaging and decorating commander 22 may run a tool for transforming inversion data from seismic inversion software to industry-standard cornerpoint grid formats suitable for reservoir modeling and flow simulations. Such a tool may be the exemplary tool described in the paper “DeliveryMassager: A Tool for Propagating Seismic Inversion Information Into Reservoir Models,” James Gunning et al., (submitted to Computers & Geosciences for publication on Feb. 23, 2006), which is hereby incorporated by reference and is available at http://oplink.net/˜glinsky/tech_papers/DeliveryMassager.pdf Massaging and decorating commander 22 may operate in system 10 as described above for wavelet extraction commander 22 and amplitude extraction commander 22.

XML Editor Commander

As discussed above, data (e.g., seismic data) that is analyzed and used by commanders 22 and self-commanders 24 in system 10 may include XML metadata containing the variable information. When performing analyses using commanders 22 and self-commanders 24, a user may want to edit this XML metadata to adjust computations or results of analysis. XML editor commander 22 may run an XML editor to edit the XML metadata and other XML data. XML editor commander 22 is invoked as other commanders 22 discussed above. As noted above, XML editor commander 22 may be invoked by a user selection in another active commander 22, or self-commander 24, GUI. XML editor commander 22 sends command messages to client-side services 16 and/or server-side services 18 to retrieve XML data files, displays the XML data (e.g., in a viewer self-commander 24), receives and stores user changes, and sends command messages to client-side services 16 and/or server-side services 18 to save edited XML data files.

Component Intercommunication Example

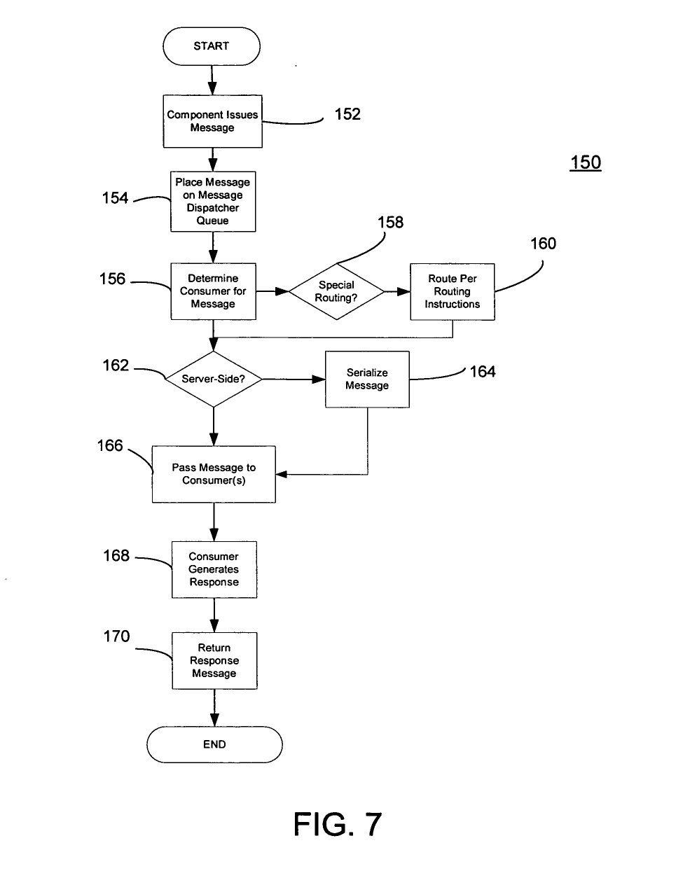

With reference now to FIG. 7, shown is a flowchart illustrating exemplary message passing 150 in an embodiment of method and system providing a graphical environment with intelligent plug-ins as described herein. Client-side component 16 instance issues a message (block 152). Message may be a command or data. Component sends a message using component's messaging manager 32 instance. Messaging manager 32 places command message on message dispatcher's 34 queue (which it knows from component instance registration when component instance launched—see above) (block 154). Message dispatcher 34 determines consumer for message (block 156). Ordinarily, the message dispatcher 34 examines message and determines consumer component for message from consumer component CID included in message. Alternatively, message dispatcher 34 may determine if there is any special routing for message (block 158). For example, certain components may monitor messages from other components. Further, a user may request that certain messages be broadcasted. Indeed, message from component may be a command requesting message dispatcher 34 to forward all messages from a component or to broadcast all messages from a component. Moreover, message may be marked for special routing, as described above. If there is special routing, message dispatcher 34 routes messages per routing instructions (e.g., per routing matrix).

If message consumer is a server-side component 18, including servlet dispatcher 38 (block 160), message dispatcher 34 passes message to dispatcher connector 36 and dispatcher connector 36 may serialize message for transmission to server 14 (block 162). In an embodiment, the message is not serialized if client 12 and server 14 are resident on the same computer. In such an embodiment, workbench application is a stand-alone application and there is, in affect, only a client 12. Per the above, the message is passed to the message consumer(s) (block 164). If message is sent to server-side component 18, servlet dispatcher 38 de-serializes the message on receipt. The message is placed on consumer's message queue (block 166). Consumer processes message, performing any requested tasks, and generates a response(s) message (block 168). Note, some command messages do not require a response message. For example, a command message may simply request message dispatcher 34 forward all messages of a certain type or from a certain component. No response message is needed to this message. Rather, the “response” would be message dispatcher 34 forwarding the requested messages. Response message is returned to producer (block 170) in a manner similar to the above (see blocks 154-166). Response message includes CID of producer, obtained from original message by consumer.

If there is an error exception when processing a message, consumer provides an abnormal response whose content provides details about the exception. It is up to the producer of the message how to handle an abnormal response (e.g., send message again, display error message, etc.).

Exemplary Hardware

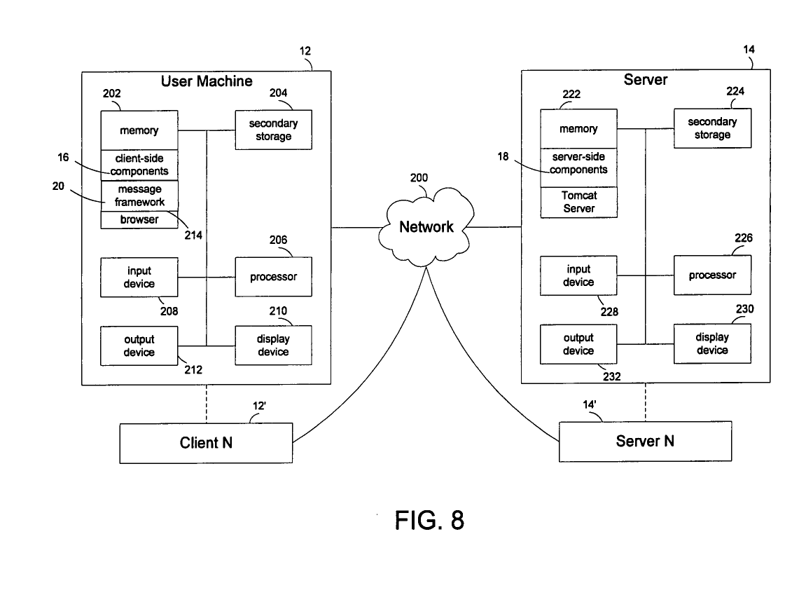

With reference now to FIG. 8, shown is a block diagram illustrating exemplary hardware components for implementing system 10 for providing a graphical environment with intelligent plug-ins. Hardware components includes client 12 (user machine) connected with a network such as the Internet 200, providing a network connection to server(s) 14. Other user machines, such as client 12′, may also be connected via network 200 to server 14. Client 12′, and other clients, may include the same components as client 12.

Client 12 illustrates typical components of a user machine. Client 12 typically includes a memory 202, a secondary storage device 204, a processor 206, an input device 208, a display device 210, and an output device 212. Memory 202 may include random access memory (RAM) or similar types of memory, and it may temporarily store one or more active client-side components 16, client-side aspects of message framework 20, a web browser 214, or other applications, for execution by processor 206. Secondary storage device 204 may include a hard disk drive, floppy disk drive, CD-ROM drive, or other types of non-volatile data storage, and may store client-side components 16 and data for use by system 10. Processor 206 may execute applications or programs, including client-side components 16, stored in memory 202 or secondary storage 204, or received from the Internet or other network 200, and the processing may be implemented in software, such as software modules, for execution. These applications preferably include instructions executable to perform the methods described herein.

Input device 208 may include any device for entering input or user selections into client 12, such as a keyboard, mouse, cursor-control device, touch-screen, microphone, digital camera, video recorder or camcorder. The input device 208 may be used to enter information into GUIs during operations of system 10, as described above. Display device 210 may include any type of device for presenting visual information such as, for example, a computer monitor or flat-screen display. The display device 210 may display workbench 50, client desktop 60, and the various GUIs described above. Output device 212 may include any type of device for presenting a hard copy of information, such as a printer, and other types of output devices include speakers or any device for providing information in audio form.

Web browser 214 is used to install system 10, as described above. Examples of web browsers include Netscape Navigator, Microsoft IE, Firefox, Opera, etc. In an embodiment, web browser 214 includes Java plug-ins. Any web browser, co-browser, or other application capable of retrieving content from a network and displaying pages or screens may be used. Examples of clients 12 for interacting with system 10 include personal computers, laptop computers, notebook computers, palm top computers, network computers, or any processor-controlled device capable of executing a web browser or other type of application for interacting with system 10.

With continuing reference to FIG. 8, server 14 typically includes a memory 222, a secondary storage device 224, a processor 226, an input device 228, a display device 230, and an output device 232. Memory 222 may include RAM or similar types of memory, and it may store one or more applications, including server-side components 18, server-side aspects of message framework 20, server software (e.g., Tomcat server), for execution by processor 226. Secondary storage device 224 may include a hard disk drive, floppy disk drive, CD-ROM drive, or other types of non-volatile data storage. Processor 226 executes server-side components 18 and other application(s), which are stored in memory 222 or secondary storage 224, or received from the Internet or other network 200. Input device 228 may include any device for entering information into server 14, such as a keyboard, mouse, cursor-control device, touch-screen, microphone, digital camera, video recorder or camcorder. Display device 230 may include any type of device for presenting visual information such as, for example, a computer monitor or flat-screen display. Output device 232 may include any type of device for presenting a hard copy of information, such as a printer, and other types of output devices include speakers or any device for providing information in audio form.

Server 14 may store a database structure in secondary storage 224, for example, for storing and maintaining information used by system 10. For example, it may maintain a relational or object-oriented database for storing information such as component saved state information, registered component information, user preferences, etc. Secondary storage 224 may also storing data used by system 10, including without limitation, sub-surface data used in sub-surface data embodiment, point-collected data described above, etc. Such information and data may be retrieved by server-side services 40.

Although only one server 14 is shown, system 10 may use multiple servers 14 as necessary or desired to support system 10. In an embodiment, client 12 and server 14 may be the same machine. Client 12 and server 14 may also be connected to other computers via Internet or other network, such as a cluster for performing cluster jobs. In addition, although client 12 and server 14 are depicted with various components, one skilled in the art will appreciate that these machines and the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling client 12 and server 14, to operate in the manners described herein.

As mentioned above, the uses of system 10 and workbench 50 are virtually unlimited. Commanders 22 and self-commanders 24 may be created for virtually any purpose. Data that may be manipulated and operated on by system 10 is also virtually unlimited. Because of the unique architecture of system 10 it is very flexible and highly efficient. Multidimensional data analysis may be performed using, e.g., 2D and 3D viewer self-commanders 24 and commanders 22 that interact with each other, e.g., as described herein. Workbench 50 provides a portable graphical working environment that a user can take to any client 12 that can connect to server 14 over the Internet or other network. Highly intensive computational operations may be performed, e.g., via cluster jobs on a cluster of servers, without sacrificing processing efficiency. Components intelligently monitor and save state information. An open messaging framework is utilized that enables any component to listen and monitor messages, taking intelligent actions based on monitored messages. Users may quit workbench 50 and component sessions, restoring from saved states to continue at a later time. Components may be added to system 10 to provide increased functionality. Client-heavy nature of workbench 50 facilitates these features and each use of system 10.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. A platform for analysis of point-gathered data comprising:
a workbench providing a graphical working environment for a user to view and perform operations on point-gathered data and to interact with the platform;
one or more plug-ins that operate on the point-gathered data, including plug-ins that receive inputs from a user through workbench and issue commands as messages and that actively save their state by passing the state as a message; and
a message framework that receives all messages from producer plug-ins and passes the messages to an intended consumer, in which the platform actively saves the workbench state and plug-in states as messages passed to the message framework.

2. The platform of claim 1 further comprising one or more services that execute commands from other plug-ins and return responses to the commands as messages sent through the message framework.

3. The platform of claim 2 in which the one or more services include input/output (IO) services.

4. The platform of claim 2 in which the one or more services include job services for executing and monitoring jobs generated by plug-ins.

5. The platform of claim 1 in which the plug-ins include commanders that provide certain functions and issue messages that include commands and data and receive messages that include data.

6. The platform of claim 5 in which the certain functions include performing computational algorithms on the point-gathered data.

7. The platform of claim 5 in which new commanders may be added to the platform to increase the functionality of the platform.

8. The platform of claim 7 in which the platform is provided under an open-source license and the new commanders are provided under a separate license.

9. The platform of claim 1 in which the plug-ins include self-commanders that issue messages that include commands and data and receive messages that include data or commands and data.

10. The platform of claim 9 in which the self-commanders include viewer self-commanders that display the point-gathered data.

11. The platform of claim 1 further comprising a client computer and a server, in which the plug-ins are resident on and executed on the client computer.

12. The platform of claim 11 in which plug-in and workbench states are saved on the server.

13. The platform of claim 11 in which the point-gathered data is saved on the server.

14. The platform of claim 13 in which selected portions of the point-gathered data are retrieved from the server and saved on the client computer.

15. The platform of claim 11 further comprising one or more client-side services on the client and one or more server-side services on the server and in which the client-side services and server-side services execute commands from plug-ins and return responses to the commands.

16. The platform of claim 1 in which the one or more plug-ins generate and display graphical user interfaces (GUIs) on the workbench.

17. The platform of claim 1 in which the one or more plug-ins include core plug-ins that are provided for free with an installation of the platform and commercial plug-ins that are separately provided and licensed to the user.

18. The platform of claim 1 in which the messaging framework comprises a messaging manager that comprises a message handler and a message queue for each plug-in.

19. The platform of claim 1 in which the point-gathered data is actively or passively gathered.

20. The platform of claim 1 in which the point-gathered data includes seismic data.

21. The platform of claim 1 in which the point-gathered data includes financial data.

22. The platform of claim 1 in which the point-gathered data includes gaming data.

23. The platform of claim 1 in which the point-gathered data include military data.

24. The platform of claim 1 in which the point-gathered data include medical data.

25. The platform of claim 1 in which the plug-ins include plug-ins that monitor messages received by the message framework.

26. The platform of claim 1 in which the message framework broadcasts certain received messages to all plug-ins.

27. The platform of claim 1 in which the message framework broadcasts certain received messages to selected plug-ins.

28. The platform of claim 1 wherein the operations performed on the data by the plug-ins include analysis of the data.

29. The platform of claim 1 wherein the operations performed on the data by the plug-ins include multidimensional analysis of the data.

30. A system for providing a graphical web-based environment for performing operations on data comprising:
a client operating on a user machine, including:
a workbench that provides a graphical working environment for a user to interact with and operate a plurality of components;
a plurality of components operating in the workbench, including:
one or more commanders that analyze and perform operations on data, in which each commander includes state-saving, state-restoring and message passing capabilities, receives inputs from the user through the workbench, issues commands and receives responses; and
one or more self-commanders that receive inputs from the user through the workbench, issue and receive commands, and issue and receive responses; and
one or more client-side services that perform services on the client per commander or self-commander issued commands and issues responses to the commands; and
a message framework, in which the components communicate with each other using messages passed through the message framework, in which each message is passed through the message framework and includes data or data and a command and the commands and responses issued by components are sent as messages;
a server in which the server stores information regarding the components, including the state and identity of registered components.

31. The system of claim 30 in which the system is configured to accept and operate with additional, third-party developed components referred to as commercial components.

32. The system of claim 30 in which the server is resident on a remote machine.

33. The system of claim 30 in which the message framework comprises a message dispatcher resident on the client and a servlet dispatcher resident on the server, and the message dispatcher receives and process messages and passes messages to the servlet dispatcher for execution on the server.

34. The system of claim 30 in which the server comprises one or more server-side services that perform services on the server per issued commands and issues responses to the commands.

35. The system of claim 30 in which the components further include system components for managing the system and the state-saving.

36. The system of claim 35 in which the system components include:
a workbench manager that manages the workbench and provides a workbench GUI for the user to control the workbench and launch components; and
a state manager that manages the state of the workbench and components.

37. The system of claim 30 in which the one or more commanders include an XML editor commander that is used to edit XML data.

38. The system of claim 30 in which the self-commanders include one or more viewer self-commanders that display the data and results of operations on the data performed by commanders.

37. The system of claim 36 in which the viewer self-commanders include a two-dimensional (2D) viewer.

38. The system of claim 36 in which the viewer self-commanders include a three-dimensional (3D) viewer.

39. The system of claim 28 in which the messaging framework comprises a messaging manager that comprises a message handler and a message queue for each commander and each self-commander.

40. The system of claim 28 in which the message framework extends to the server and the server comprises elements of the message framework.

41. A method for providing a graphical web-based environment for performing operations on data comprising:
connecting to a server from a client computer;
opening a workbench on the client computer, in which the workbench provides a graphical working environment for a user to interact with and operate a plurality of components;
starting up a message framework, in which the components communicate with each other using messages passed through the message framework, in which each message is passed through the message framework and includes data or data and a command;
launching one or more commander components on the client computer, in which commander components analyze and perform operations on data, in which each commander component includes state-saving, state-restoring and message passing capabilities, receives inputs from the user through the workbench, issues commands and receives responses;
launching one or more self-commanders on the client computer, in which the self-commanders receive inputs from the user through the workbench, issue and receive commands, and issue and receive responses; and
saving the state of at least one of the commander components on the server.

42. The method of claim 41 further comprising:
receiving a user input through the workbench; and
one of the commander components issuing a command in response to the user input.

43. The method of claim 41 further comprising launching one or more client-side services on the client computer, in which the client-side services perform services on the client per commander or self-commander issued commands and issues responses to the commands.

44. The method of claim 41 further comprising launching one or more server-side services on the client computer, in which the server-side services perform services on the server per commander or self-commander issued commands and issues responses to the commands.

45. The method of claim 41 in which saving the state of at least one of the commander components on the server comprises the at least one commander component sending a message that comprises the at least one commander state information to the message framework.

46. The method of claim 41 further comprising restoring the state of the at least one commander component.

47. The method of claim 46 in which restoring the state of the at least one commander component comprises:
retrieving saved state information from the server; and
restoring the at least one commander to the state indicated by the saved state information.

48. The method of claim 41 further comprising operating at least one of the commander components based on user input.

49. The method of claim 41 in which the self-commanders include a viewer self-commander that displays the data and results of the analysis and operations on the data performed by commander components, the method further comprising the viewer self-commander displaying data in response to user input.

50. A computer readable medium comprising instructions for executing the steps of the method of claim 41.

51. A computer readable medium comprising instructions for providing a graphical web-based environment for performing operations on data, by:
opening a workbench on the client computer, in which the workbench provides a graphical working environment for a user to interact with and operate a plurality of components;
starting up a message framework, in which the components communicate with each other using messages passed through the message framework, in which each message is passed through the message framework and includes data or data and a command;
launching one or more commander components on the client computer, in which commander components analyze and perform operations on data, in which each commander component includes state-saving, state-restoring and message passing capabilities, receives inputs from the user through the workbench, issues commands and receives responses;
launching one or more self-commanders on the client computer, in which the self-commanders receive inputs from the user through the workbench, issue and receive commands, and issue and receive responses; and
saving the state of at least one of the commander components on a server.

52. The computer readable medium of claim 51 further comprising instructions for:
receiving a user input through the workbench; and
one of the commander components issuing a command in response to the user input.

53. The computer readable medium of claim 51 further comprising instructions for launching one or more client-side services on the client computer, in which the client-side services perform services on the client per commander or self-commander issued commands and issues responses to the commands.

54. The computer readable medium of claim 51 further comprising instructions for launching one or more server-side services on the client computer, in which the server-side services perform services on the server per commander or self-commander issued commands and issues responses to the commands.

55. The computer readable medium of claim 51 in which saving the state of at least one of the commander components on the server comprises the at least one commander component sending a message that comprises the at least one commander state information to the message framework.

56. The computer readable medium of claim 51 further comprising instructions for further comprising restoring the state of the at least one commander component.

57. The computer readable medium of claim 56 in which restoring the state of the at least one commander component comprises:
retrieving saved state information from the server; and
relaunching and restoring the at least one commander to the state indicated by the saved state information.

58. The computer readable medium of claim 51 further comprising instructions for operating at least one of the commander components based on user input.

59. The computer readable medium of claim 51 in which the self-commanders include a viewer self-commander that displays the data and results of the analysis and operations on the data performed by commander components, the method further comprising the viewer self-commander displaying data in response to user input.
